(19) United States
(12) Patent Application Publication
(10) Pub. No.: US 2017/0351226 A1
(43) Pub. Date: Dec. 7, 2017

(54) INDUSTRIAL MACHINE DIAGNOSIS AND MAINTENANCE USING A CLOUD PLATFORM

(71) Applicant: Rockwell Automation Technologies, Inc., Mayfield Heights, OH (US)

(72) Inventors: Ronald E. Bliss, Twinsburg, OH (US); Sharon M. Billi, Euclid, OH (US); Christopher W. Como, Chagrin Falls, OH (US); Edward A. Gray, Olmsted Township, OH (US); Kyle K. Reissner, Hudson, OH (US); Jonathan D. Walter, Broadview Heights, OH (US); Mohit Singhai, Lyndhurst, OH (US); Douglas J. Reichard, Fairview Park, OH (US); Scott N. Sandler, Chagrin Falls, OH (US); Michael J. Pantaleano, Willoughby, OH (US); Ryan Cahalane, Chagrin Falls, OH (US); Jessica Korpela, Milwaukee, WI (US); Bruce T. McCleave, JR., Mission Viejo, CA (US)

(21) Appl. No.: 15/170,676

(22) Filed: Jun. 1, 2016

(51) Int. Cl. G05B 13/04; G05B 11/36; G05B 19/4063; G06F 17/30

(52) U.S. Cl. CPC G05B 13/042; G06F 17/3097; G06F 17/30566; G06F 17/30545; G05B 11/36; G06F 17/3053; G05B 19/4063; G05B 2219/33073

(57) ABSTRACT

A cloud-based diagnosis and maintenance system facilitates discovery and indexing of plant-wide data residing on various data platforms across multiple industrial facilities. The system includes an indexing system that automatically inventories industrial devices and other data sources located throughout the facilities, and identifies available data items on each data source. The indexing system indexes the discovered data items in a federated data model that can subsequently be searched to locate data items or tags of interest. The diagnosis and maintenance system also includes analysis tools that facilitate cross-facility analysis of the data model, allowing performance metrics to be compared across similar automation systems at different facilities. The system can also generate recommendations for improving performance metrics based on results of the comparative analysis.

### BACKGROUND

The subject matter disclosed herein relates generally to industrial automation systems, and, more particularly, to industrial machine diagnosis and maintenance.

### BRIEF DESCRIPTION

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

In one or more embodiments, a system for analyzing performance of industrial automation systems across multiple facilities is provided, comprising discovery component configured to discover available data items distributed across multiple data sources of multiple industrial facilities; an indexing component configured to record the data items in a searchable federated data model; an analysis component configured to identify sets of data items recorded in the federated data model that correspond to respective automation systems in operation at the multiple industrial facility, and to perform comparative analysis across the sets of data items; and a device interface component configured to output recommendation data based on a result of the comparative analysis, wherein the recommendation data identifies a recommended modification to one or more of the automation systems determined to improve a performance metric.

Also, one or more embodiments provide a method for improving performance of industrial automation systems, comprising discovering, by a system comprising a processor, available data items located on data sources located at multiple industrial plants; indexing, by the system, the available data items in a searchable federated data model; identifying, by the system, sets of data items indexed in the federated data model that correspond to respective automation systems operating in the multiple industrial plants; performing, by the system, comparative analysis on the sets of data items; and generating, by the system, recommendation data based on a result of the comparative analysis, wherein the recommendation data identifies a recommended modification to one or more of the automation systems determined to improve a performance metric.

Also, according to one or more embodiments, a non-transitory computer-readable medium is provided having stored thereon instructions that, in response to execution, cause a system to perform operations, the operations comprising discovering available data items located on data sources located at multiple industrial plants; indexing the available data items in a searchable federated data model; identifying sets of data items indexed in the federated data model that correspond to respective automation systems operating in the multiple industrial plants; performing comparative analysis on the sets of data items; and generating recommendation data based on a result of the comparative analysis, wherein the recommendation data identifies a recommended modification to one or more of the automation systems determined to improve a performance metric.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment.

FIG. 2 is a conceptual diagram illustrating industrial data federation.

FIG. 3 is a block diagram of an example industrial diagnosis and maintenance system.

FIG. 4 is a diagram illustrating a generalized architecture for collection, indexing, and analysis of multi-facility industrial data.

FIG. 5 is a block diagram of a generalized example architecture including an industrial diagnosis and maintenance system that discovers, indexes, and analyzes multi-facility and multi-platform data throughout an industrial environment.

FIG. 6 is a block diagram illustrating components of the industrial diagnosis and maintenance system.

FIG. 7 is a block diagram that illustrates processing performed by the industrial data indexing system.

FIG. 8 is a diagram illustrating creation of a pre-indexed sub-model 804 using indexing functionality implemented on an industrial controller.

FIG. 9 is a diagram illustrating submission of a pre-indexed sub-model from a control cabinet to the diagnosis and maintenance system for indexing.

FIG. 10 is a diagram illustrating an architecture in which discovery agent collects and indexes message log information.

FIG. 11 is a diagram of an example smart device capable of self-reporting to an indexing system.

FIG. 12 is a block diagram illustrating transformation of discovered data by a transform component.

FIG. 13 is a conceptual diagram of a generalized implementation that uses cloud agent devices on the plant floor to collect and push industrial data to the diagnosis and maintenance system for indexing.

FIG. 14 is a diagram illustrating an example data processing technique that can be implemented by an analysis component to facilitate industry-specific and application-specific comparative analysis across multiple automation systems.

FIG. 15 is a diagram illustrating an analysis performed by an analysis component to identify system configuration deviations based on analysis of the groups of configuration-specific data.

FIG. 16 is a diagram illustrating an analysis performed by an analysis component to generate plant-specific recommendations based on such analysis.

FIG. 17 is a diagram illustrating creation of backup data for a set of industrial facilities.

FIG. 18 is a diagram illustrating retrieval of backup data from the system.

FIG. 19 is a diagram illustrating cloud-based modeling and emulation.

FIG. 20 is a flowchart of an example methodology for performing comparative analysis on industrial automation systems located at multiple geographically diverse facilities.

FIG. 21 is a flowchart of an example methodology for generating automated recommendations for optimizing performance of one or more industrial automation systems.

FIG. 22 is an example computing environment.

FIG. 23 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

Industrial controllers and their associated I/O devices are central to the operation of modern automation systems. These controllers interact with field devices on the plant floor to control automated processes relating to such objectives as product manufacture, material handling, batch processing, supervisory control, and other such applications. Industrial controllers store and execute user-defined control programs to effect decision-making in connection with the controlled process. Such programs can include, but are not limited to, ladder logic, sequential function charts, function block diagrams, structured text, or other such platforms.

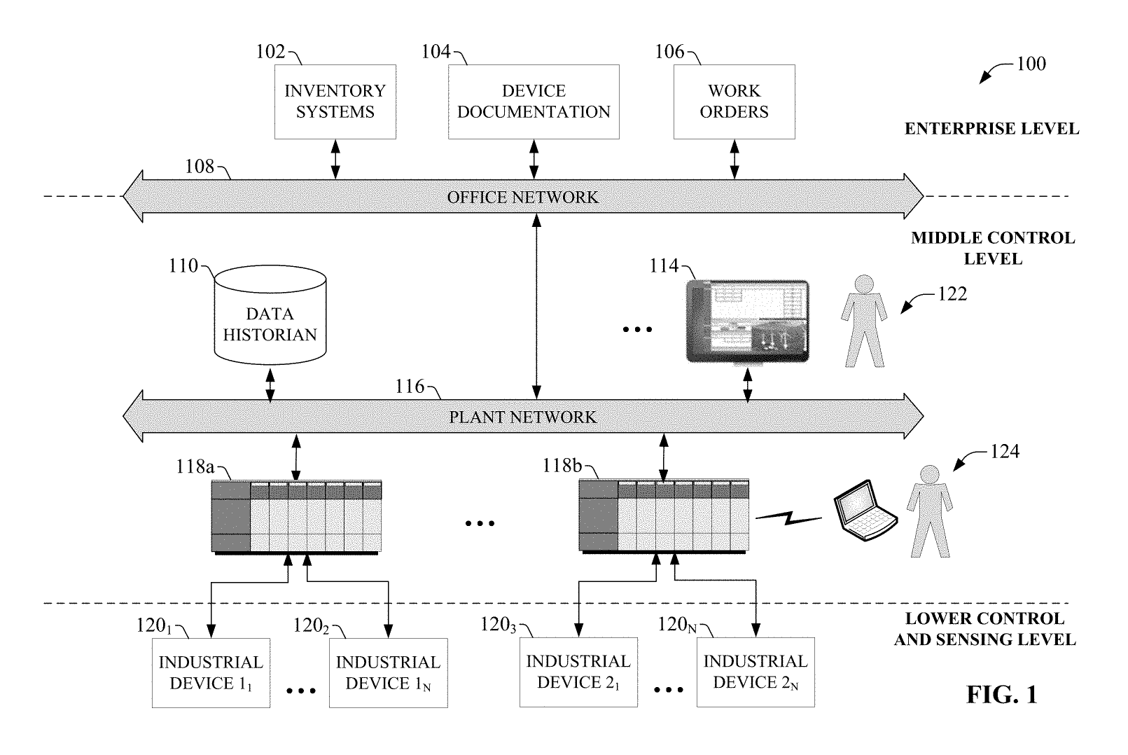

FIG. 1 is a block diagram of an example industrial control environment 100. In this example, a number of industrial controllers 118 are deployed throughout an industrial plant environment to monitor and control respective industrial systems or processes relating to product manufacture, machining, motion control, batch processing, material handling, or other such industrial functions. Industrial controllers 118 typically execute respective control programs to facilitate monitoring and control of industrial devices 120 making up the controlled industrial systems. One or more industrial controllers 118 may also comprise a soft controller executed on a personal computer or other hardware platform, or on a cloud platform. Some hybrid devices may also combine controller functionality with other functions (e.g., visualization). Some industrial controllers 118 may be composite devices designed to implement both industrial control functionality (e.g., via execution of industrial control programs) as well as standard operating system functions. The control programs executed by industrial controllers 118 can comprise any conceivable type of code used to process input signals read from the industrial devices 120 and to control output signals generated by the industrial controllers, including but not limited to ladder logic, sequential function charts, function block diagrams, or structured text.

Industrial devices 120 may include both input devices that provide data relating to the controlled industrial systems to the industrial controllers 118, and output devices that respond to control signals generated by the industrial controllers 118 to control aspects of the industrial systems. Example input devices can include telemetry devices (e.g., temperature sensors, flow meters, level sensors, pressure sensors, etc.), manual operator control devices (e.g., push buttons, selector switches, etc.), safety monitoring devices (e.g., safety mats, safety pull cords, light curtains, etc.), and other such devices. Output devices may include motor drives, pneumatic actuators, signaling devices, robot control inputs, valves, and the like.

Industrial controllers 118 may communicatively interface with industrial devices 120 over hardwired or networked connections. For example, industrial controllers 118 can be equipped with native hardwired inputs and outputs that communicate with the industrial devices 120 to effect control of the devices. The native controller I/O can include digital I/O that transmits and receives discrete voltage signals to and from the field devices, or analog I/O that transmits and receives analog voltage or current signals to and from the devices. The controller I/O can communicate with a controller's processor over a backplane such that the digital and analog signals can be read into and controlled by the control programs. Industrial controllers 118 can also communicate with industrial devices 120 over a network using, for example, a communication module or an integrated networking port. Exemplary networks can include the Internet, intranets, Ethernet, DeviceNet, ControlNet, Data Highway and Data Highway Plus (DH/DH+), Remote I/O, Fieldbus, Modbus, Profibus, wireless networks, serial protocols, and the like. The industrial controllers 118 can also store persisted data values that can be referenced by the control program and used for control decisions, including but not limited to measured or calculated values representing operational states of a controlled machine or process (e.g., tank levels, positions, alarms, etc.) or captured time series data that is collected during operation of the automation system (e.g., status information for multiple points in time, diagnostic occurrences, etc.). Similarly, some intelligent devices—including but not limited to motor drives, instruments, or condition monitoring modules—may store data values that are used for control and/or to visualize states of operation. Such devices may also capture time-series data or events on a log for later retrieval and viewing.

Industrial automation systems often include one or more human-machine interfaces (HMIs) 114 that allow plant personnel to view telemetry and status data associated with the automation systems, and to control some aspects of system operation. HMIs 114 may communicate with one or more of the industrial controllers 118 over a plant network 116, and exchange data with the industrial controllers to facilitate visualization of information relating to the controlled industrial processes on one or more pre-developed operator interface screens. HMIs 114 can also be configured to allow operators to submit data to specified data tags or memory addresses of the industrial controllers 118, thereby providing a means for operators to issue commands to the controlled systems (e.g., cycle start commands, device actuation commands, etc.), to modify setpoint values, etc. HMIs 114 can generate one or more display screens through which the operator interacts with the industrial controllers 118, and thereby with the controlled processes and/or systems. Example display screens can visualize present states of industrial systems or their associated devices using graphical representations of the processes that display metered or calculated values, employ color or position animations based on state, render alarm notifications, or employ other such techniques for presenting relevant data to the operator. Data presented in this manner is read from industrial controllers 118 by HMIs 114 and presented on one or more of the display screens according to display formats chosen by the HMI developer. HMIs may comprise fixed location or mobile devices with either user-installed or pre-installed operating systems, and either user-installed or pre-installed graphical application software.

Industrial controllers 118, industrial devices 120, and HMIs 114 are just a few sources of information relating to the industrial processes and systems being controlled within the plant environment. Some industrial environments may also include other sources of potentially relevant information relating to specific aspects of the controlled industrial systems. These may include, for example, a data historian 110 that aggregates and stores production information collected from the industrial controllers 118 or other data sources, or a device documentation store 104 containing electronic documentation for the various industrial devices making up the controlled industrial systems. Other information sources may include an inventory tracking system 102, a work order management system 106, repositories for machine or process drawings and documentation, vendor product documentation storage, vendor knowledgebases, internal knowledgebases, work scheduling applications, or other such systems, some or all of which may reside on an office network 108 of the industrial environment. These diverse information sources are spread across many locations and systems both within the plant environment and externally (e.g., on the Internet).

When diagnosing problems, maintenance personnel are often required to search several of these sources of information individually, using several different software packages specific to the respective data sources being searched. Moreover, searching for information pertaining to a particular device or machine often requires an extensive knowledge of the overall industrial system in order to locate the data source (e.g., industrial controllers, HMIs, etc.), to be searched, as well as to identify the relevant operator screens and control program routines. Individually searching each of these data sources in connection with solving a system downtime issue, an operating inefficiency, or other problem can delay correction of maintenance issues, resulting in lost revenue and scheduling problems.

Moreover, many industrial enterprises distribute their operations across multiple geographically diverse plant facilities, some of which may be designed to carry out similar manufacturing tasks. Although some industrial enterprises attempt to apply a degree of standardized between similar manufacturing tasks carried out by multiple different facilities—e.g., by standardizing on equipment, automation system designs, device vendors, machine or production line designs, etc.—the local personnel responsible for managing each facility may have a degree of independent control over their operations in terms of device configurations, industrial control programming, operator workflow practices, maintenance schedules, etc. As a result, different facilities that perform similar industrial operations may observe different results as a function of their individualized system configurations or management practices. Given the geographical separation between the facilities, identifying the system configurations that yield the best results—e.g., in terms of product quality or throughput, minimized machine downtimes, energy efficiency, etc.—and communicating these preferred configurations to other facilities carrying out similar processes is challenging.

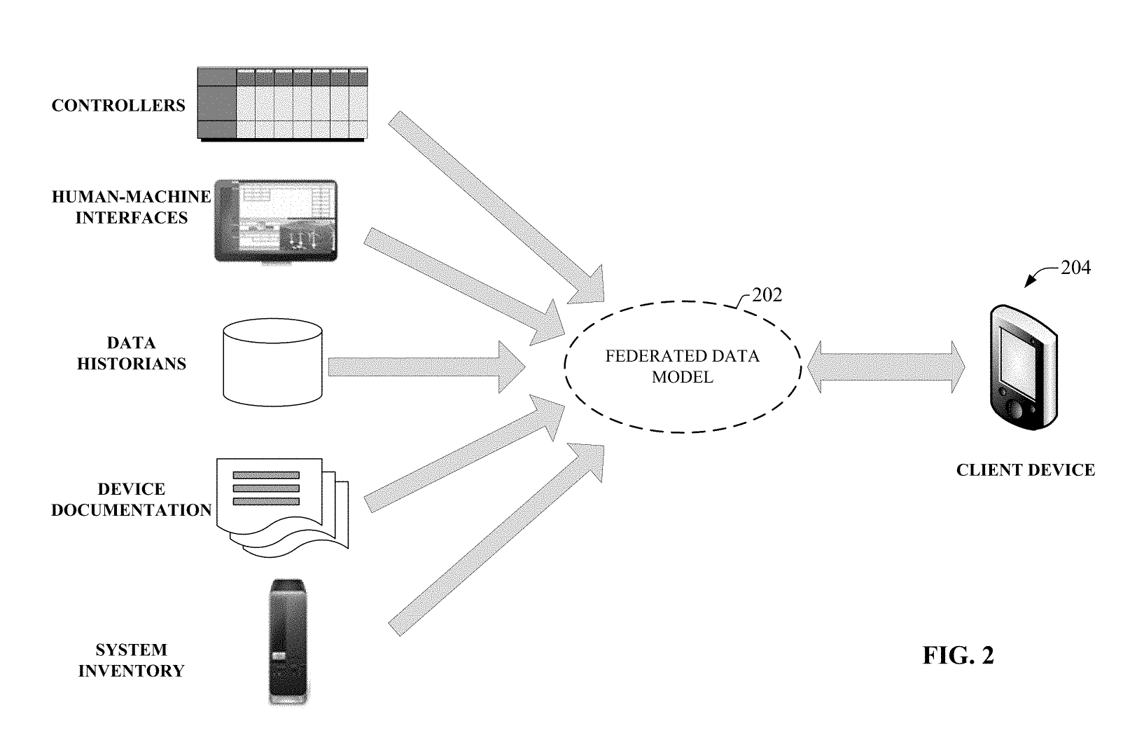

To address these and other issues, one or more embodiments of the present disclosure provide a cloud-based industrial diagnosis and maintenance system that discovers system configuration data available across multiple heterogeneous data platforms at diverse industrial facilities, and indexes the configuration data in a unified searchable namespace for analysis. The diagnosis and maintenance system unifies plant-wide control system information from multiple diverse sources, and from multiple facilities of an industrial enterprise, under a common namespace or federated data model. FIG. 2 is a conceptual diagram illustrating this industrial data federation. In one or more embodiments, the diagnosis and maintenance system indexes data from multiple sources both across the industrial facilities and external to the facility, including but not limited to industrial controllers, HMIs, intelligent industrial devices, motor drives, industrial safety systems, data historians, device and system documentation repositories (e.g., drawings, manuals, knowledgebase articles, etc.), system inventory management systems, computer-based control applications (e.g., enterprise resource planning systems, batch process management systems, etc.), batch software, product control software, structured query language (SQL) databases that interact with the control system, and/or other such platforms. The system indexes and correlates this multi-platform and multi-plant data to yield a federated data model 202 that can be accessed and searched by a client device 204, allowing system configuration data to be viewed for the enterprise as a whole.

In addition, the system's analytics tools can analyze the federated namespace on the cloud platform in order to compare performance metrics for similar machines or industrial systems at different plant facilities. For example, a cloud-based analytics service can identify similar machines or workcells at different plant facilities, and compare the relative performance of these machines. Further analysis can determine which location is achieving the best performance metrics for the machine, and identify factors that may contribute to that machine's superior performance (e.g., a particular operator workflow, configuration settings, maintenance schedules, firmware versions, programming changes etc.). The system can then generate recommendations for bringing similar assets at other locations in line with the best performing version of the asset.

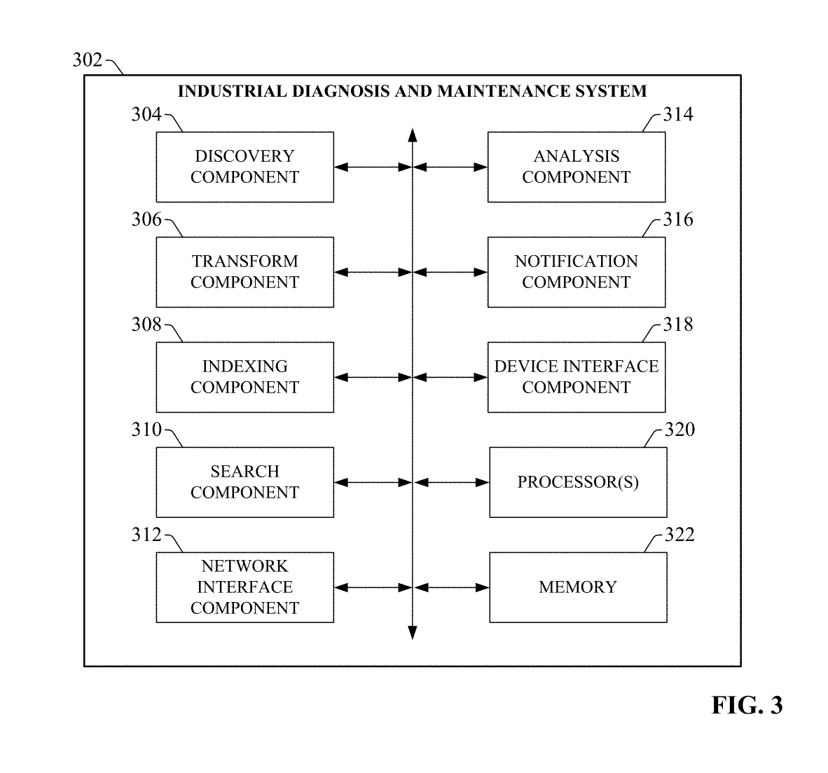

FIG. 3 is a block diagram of an example industrial diagnosis and maintenance system 302 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Industrial diagnosis and maintenance system 302 can include a discovery component 304, a transform component 306, an indexing component 308, a search component 310, a network interface component 312, an analysis component 314, a notification component 316, a device interface component 318 one or more processors 320, and memory 322. In various embodiments, one or more of the discovery component 304, transform component 306, indexing component 308, search component 310, network interface component 312, analysis component 314, notification component 316, device interface component 318, the one or more processors 320, and memory 321 can be electrically and/or communicatively coupled to one another to perform one or more of the functions of the industrial diagnosis and maintenance system 302. In some embodiments, components 304, 306, 308, 310, 312, 314, 316, and 318 can comprise software instructions stored on memory 322 and executed by processor(s) 318. Industrial diagnosis and maintenance system 302 may also interact with other hardware and/or software components not depicted in FIG. 3. For example, processor(s) 320 may interact with one or more external user interface devices, such as a keyboard, a mouse, a display monitor, a touchscreen, or other such interface devices.

Discovery component 304 can be configured to gather information from one or more industrial automation systems and other data sources both internal and external to an industrial environment. In this regard, the discovery component 304 can index data from multiple industrial facilities associated with a common industrial enterprise (e.g., the plant facilities of a given parent company), or may index data from multiple facilities of different industrial enterprise for cross-enterprise analysis. The discovery component 304 can also be configured to discover interdependencies between the data items.

Transform component 306 can be configured to transform and tag the data discovered by the discovery component prior to indexing. This can include, for example, transforming heterogeneous data items discovered on different types of data platforms to a homogeneous format for indexing under a common namespace, tagging the discovered data with relevant contextual information—e.g., a plant, production area, machine, or device on which the data was discovered; a relationship or interdependency between a given data item and another data item; a data platform corresponding to the data item (e.g., industrial control program, HMI application, knowledgebase article, device documentation, etc.)—or other data modifications. The indexing component 308 can be configured to generate a federated data model (e.g., federated data model 202) defining locations and sources of data items throughout the industrial system, as well as relationships between the data items, based on the discovered and transformed data. The resulting federated data model is capable of identifying and reporting sources of specific data items or tags, as well as relevant contextual data relating to a specified data item.

Search component 310 can be configured to submit search queries to the federated data model and retrieve search results identifying locations of requested data items throughout the industrial system. In some embodiments, search component 310 can be configured to classify the search results according to the platform of the respective data sources on which the results were found (e.g., control logic, HMI, etc.), as well as the network and/or physical location (e.g., production area) in which the information is located. For search results corresponding to web content (e.g., vendor knowledgebase websites), the search component 310 can generate links that facilitate direct navigation to the web content. Network interface component 312 can be configured to exchange information between the industrial diagnosis and maintenance system 302 and a plant network and/or external network (e.g., a public network such as the Internet). This communication can include, for example, deployment of data discovery agents and receipt of discovered data items from the discovery agents or directly from data sources themselves.

Analysis component 314 can be configured to perform cross-facility analysis on the data contained in the federated data model, and generate notifications or recommendations identifying alternate configurations or practices that may yield improved results at one or more of the facilities. In an example embodiment, analysis component 314 may be configured to identify data associated with similar industrial systems at different facilities, and to identify differences in the configurations of these systems. By correlating these configuration differences with specified performance metrics for the respective systems, the analysis component 314 can identify system configurations that may produce superior results, and generate recommendations to reconfigure similar systems at other facilities to conform to the preferred configuration. Other types of analysis can also be performed by analysis component 314 in various embodiments, as will be described in more detail herein.

Notification component 316 can be configured to generate and deliver notifications of the detected issues or analytical results to one or more client devices associated with selected plant personnel. Device interface component 318 can be configured to exchange information between the diagnosis and maintenance system 302 and a client device having authorization to access the system. For example, the device interface component 318 can receive search queries from the client device for submission to the federated data model, as well as deliver search or analysis results and notifications to the client device.

The one or more processors 320 can perform one or more of the functions described herein with reference to the systems and/or methods disclosed. Memory 322 can be a computer-readable storage medium storing computer-executable instructions and/or information for performing the functions described herein with reference to the systems and/or methods disclosed.

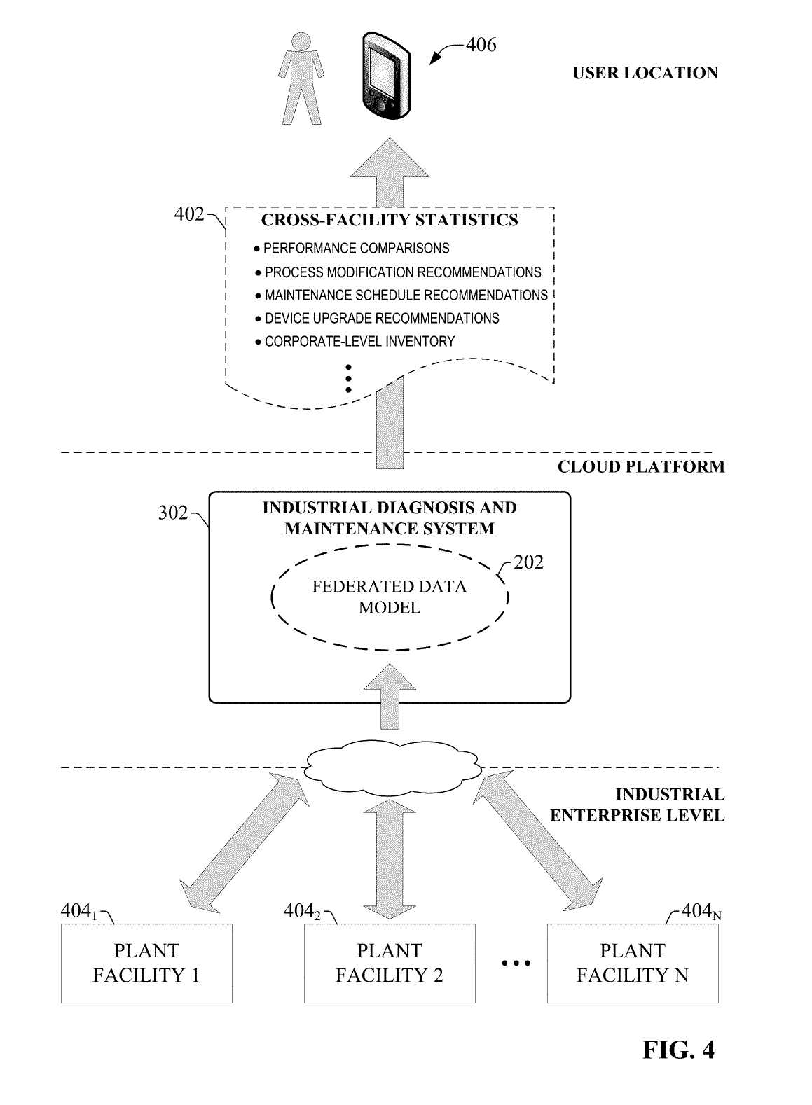

FIG. 4 is a diagram illustrating a generalized architecture for collection, indexing, and analysis of multi-facility industrial data. In one or more embodiments, industrial diagnosis and maintenance system 302 can reside on a cloud platform and execute as cloud service. The cloud platform can be any infrastructure that allows industrial diagnosis and maintenance system 302 to be accessed and utilized by cloud-capable devices. The cloud platform can be a public cloud accessible via the Internet by devices having Internet connectivity and appropriate authorizations to utilize the diagnosis and maintenance system 302. In some scenarios, the cloud platform can be provided by a cloud provider as a platform-as-a-service (PaaS), and the diagnosis and maintenance system 302 can reside and execute on the cloud platform as a cloud-based service. In some such configurations, access to the cloud platform and the diagnosis and maintenance system 302 can be provided to customers as a subscription service by an owner of the diagnosis and maintenance system 302. Alternatively, the cloud platform can be a private or semi-private cloud operated internally by the enterprise, or a shared or corporate cloud environment. An example private cloud can comprise a set of servers hosting the diagnosis and maintenance system 302 and residing on a corporate network protected by a firewall.

As will be described in more detail below, the system's discovery, transform, and indexing components locate and collect facility data from multiple plant facilities 404 of an industrial enterprise, and index this data in a federated data model 202. The collected multi-facility data can include, for example, information identifying the industrial devices deployed at each facility 404 to carry out one or more industrial processes, configuration settings for the respective industrial devices, firmware versions installed on the devices, controller programming, machine configuration data, performance metrics for specific machines or production lines (e.g., product counts, production rates, product quality metrics, machine downtime statistics, etc.), inventory levels, work or maintenance schedules, or other such information. The system 302 indexes this information in a federated data model 202 that can be searched and analyzed by the system's cloud analytics services.

Based on cross-facility analysis of the federated data model 202, the diagnosis and maintenance system 302 can generate cross-facility statistics 402 for the industrial enterprise to which the facilities belong. These statistics can include, for example, performance comparisons between similar industrial systems at different industrial facilities. Such performance comparisons can identify factors that may cause a system at a first facility to achieve better performance metrics than a similar system at a second facility. These factors may include, for example, device configuration settings, industrial controller programming, maintenance or operating schedules, operator workflows, device models or versions, device firmware versions, or other such factors. In a related aspect, the system 302 can also generate process modification recommendations, maintenance schedule recommendations, device upgrade recommendations, or other such recommendations based on the performance comparisons and the identified key factors that are determined to play a role in achieving superior performance metrics. The model 202 can also be accessed to determine a corporate-level or enterprise-level product inventory that includes an aggregation of all available products at all facilities. These statistics and recommendations can be delivered to any suitable client device 406 having authorized access to the diagnostic and maintenance services on the cloud platform.

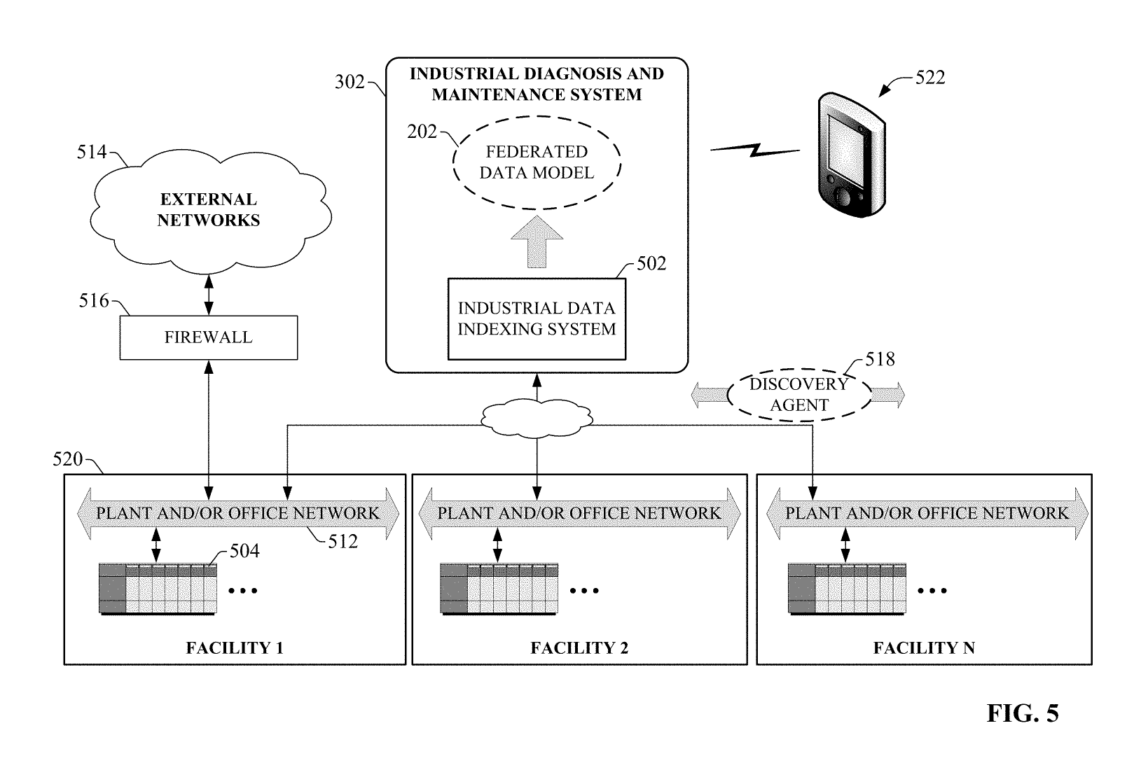

FIG. 5 is a block diagram of a generalized example architecture including an industrial diagnosis and maintenance system 302 that discovers, indexes, and analyzes multi-facility and multi-platform data throughout an industrial environment. In this example architecture, industrial diagnosis and maintenance system 302 resides on a cloud platform, where the search system executes as a cloud-based service. From the cloud platform, system 302 is communicatively connected to the plant and/or office networks 512 of multiple industrial facilities 520, where each facility 520 includes a number of industrial assets which are viewed as data sources by the diagnosis and maintenance system 302. Example industrial assets residing at the various facilities 520 can include, but are not limited to, industrial controllers 504, HMIs, databases (e.g., data historians, employee databases, inventory databases, etc.), device documentation repositories, product inventory tracking systems, work order management systems, etc. These industrial data sources reside on the plant and/or office networks 512 of the facilities 520. In some scenarios, the industrial assets may be distributed across multiple networks within each plant facility; e.g., a plant network and an office network communicatively connected through a firewall device or other network infrastructure device. Networks 512 may also have access to external networks 514 such as the Internet (e.g., via firewall 516).

Industrial data indexing system 502—which comprises the discovery component 304, transform component 306, and indexing component 308 of the diagnosis and maintenance system 302—discovers and indexes data items that are available in the disparate data sources located at the various facilities (e.g., the industrial controllers 504, HMIs, maintenance schedules, inventory databases, etc.) as well as on the external networks 514. Industrial data indexing system 502 also indexes relationships between the data items. This can include, for example, recording instances of the same data item residing in multiple data sources at a given facility (e.g., recording that a data tag corresponding to a particular temperature measurement within one of the industrial controllers 504 corresponds to a data tag within one of the HMIs for displaying the temperature measurement on a display screen), observing that values of certain data items are a function of other data items (e.g., an output coil associated with a first data tag in a ladder logic program is set based on a value of a second data tag used as an output condition for the rung), or other such relationships.

To facilitate discovery and indexing, the industrial data indexing system 502 can deploy a discovery agent 518 on each of the plant networks 512. The discovery agent 518 may comprise, for example, a software script that crawls its assigned network 512 to discover industrial devices and other data sources—both internal to the plant as well as external sources—containing available data items. The discovery agent 518 can report the discovered data items to the discovery and indexing system 502, which converts the data to a common searchable format, contextualizes the data using predefined or automatically generated tags, identifies any interdependencies between the data items, and indexes the data in the federated data model for subsequent searching.

Each discovery agent 518 traverses the network on which it is deployed and discovers data sources (e.g., industrial devices, knowledge bases, device documentation storage devices, work schedules, maintenance record databases, electronic communication records, etc.) and the data items available on each data source. In some embodiments, the discovery agent 518 can also traverse external networks 514 to discover relevant external sources of data, including but not limited to vendor websites or knowledgebases. The discover agent 518 can return information describing the discovered data to the industrial data indexing system 502 for processing and indexing within the federated data model 202. In this way, the industrial data indexing system 502 automatically inventories a customer's industrial environment by discovering the industrial assets in use and their associated available data items. Industrial data indexing system 502 can also discover relevant data on data sources residing on the external networks 514, including but not limited to device or machine vendor documentation, relevant online knowledgebase articles, vendor product release information, etc.

Industrial data indexing system 502 records the indexed information (that is, the discovered plant-wide data items and their relationships) as a federated data model 202, which can be remotely accessed and searched by a client device 522 to locate desired data items. System 302 also allows client device 522 to access results of generated by analysis component 314 (not shown in FIG. 5) based on multi-facility analysis performed on the data model 202. Client device 522 can be any mobile device (e.g., mobile phone, laptop computer, tablet computer, wearable computer, etc.) or fixed location computer (e.g., desktop computer, server, operator interface, etc.) capable of remotely accessing system 302.

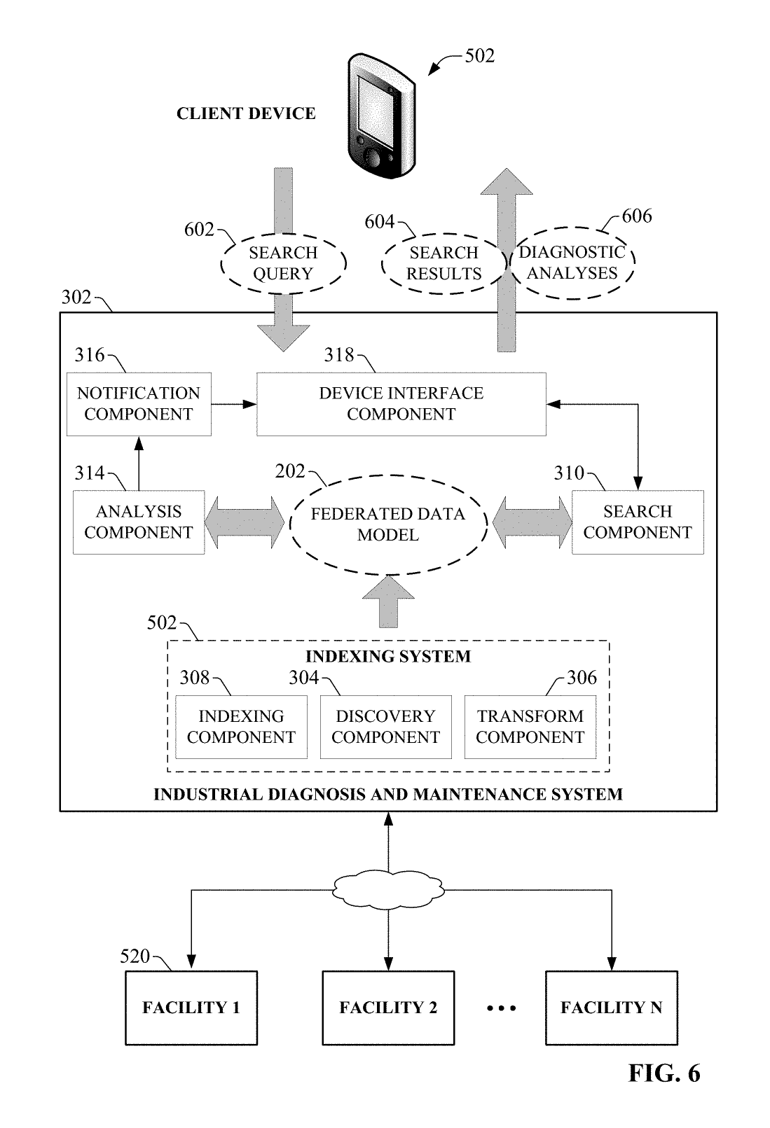

FIG. 6 is a block diagram illustrating components of the industrial diagnosis and maintenance system 302 in more detail. In some embodiments, the diagnosis and maintenance system 302 may be implemented on a web server, allowing client devices to remotely search the federated data model 202 or to access analysis results via a web connection. In other embodiments, the search system may be implemented as a cloud-based service that executes on a cloud platform. For cloud-based embodiments, communication between the cloud platform and both plant floor devices and client devices can be secured using any suitable communication security technique. For example, in some embodiments industrial devices at the facilities 520 (as well as client devices, such as client device 502) may be configured to perform a security key exchange with the cloud-based system, and to perform encrypted data exchange with the system 302.

Indexing system 502—comprising discovery component 304, transform component 306, and indexing component 308—collects information about available data items distributed across a customer's geographically diverse industrial facilities, and generates federated data model 202 representing a searchable unified view of the discovered data. The indexing system 502 is configured to discover data items on multiple disparate platforms, including but not limited to industrial controllers, HMIs, databases, electronic documentation libraries, inventory tracking systems, work order management systems, etc. The indexing system 502 can discover available data items by deploying discovery agents 518 on the plant or office networks on which the data sources reside. These agents traverse network 412 and identify devices in use throughout the plants, as well as the data items or tags, applications, and configuration information associated with those devices. Since a given industrial environment typically comprises a heterogeneous collection of devices of different types and vendors, and the data made available by these devices may comprise many different data types (e.g., controller tags, HMI tags, alarms, notifications, events, data values, tabular data, logs, configuration settings, diagnostic values, alarms, HTML pages, etc.), indexing system 502 can manage and deploy device-specific or platform-specific agents configured to extract and analyze information from specific types of devices or data platforms (e.g., controllers, HMIs, etc.). Some device-specific discovery agents can be configured to locate application project files stored on particular device types (e.g., configuration and/or program files on an industrial controller, screen configuration files on an HMI, etc.), and extract relevant information about the devices based on analysis of data contained in these project files. By leveraging device-specific and platform-specific agents, the indexing system 502 can discover and index data conforming to many different formats and platforms.

In order to unify this disparate heterogeneous data under a common platform for collective searching, the discovery agents can transform the collected data to a format understandable by the indexing system 502 (e.g., extensible markup language or other format), and the indexing system 502 can index this transformed data using a common indexing format compatible with the common search platform. The indexing system 502 then encodes this normalized representation of the discovered data in the federated data model 202. By unifying the distributed data under this unified search platform, the system can allow client devices to search the plant-wide data without knowledge of the rules or protocols for reading the various data source platforms (e.g., industrial controllers, HMIs, etc.). In addition to discovery of devices and their associated data via discovery agents deployed on the plant network, some embodiments of indexing system 502 can also be configured to receive uploaded configuration information from devices that support self-identification functionality, as will be described in more detail herein.

Indexing system 502 can also discover and record relationships—both explicit and inferred—between discovered data items. In some embodiments, the indexing system 502 may record these relationships by tagging discovered data items and building the search index based on these tags, such that related data items share common tags. In some scenarios, these tags may be explicitly defined by a system developer such that the indexing component determines which predefined tags should be applied to newly discovered data items.

Using some or all of these techniques, the indexing system 502 can automatically build a unified model of the customer's geographically diverse industrial enterprise, including the disparate and multi-platform devices in use throughout each plant, their associated available data items, and relationships between these data items. This eliminates the need for plant personnel to have full knowledge of the industrial assets in use throughout the plants, since indexing system 502 can automatically inventory each industrial environment and record discovered devices and data in federated data model 202.

Once created by the indexing system 502, federated data model 202 can be searched by search component 310. Search component 310 is configured to search federated data model 202 in response to a search query 602 submitted by a client device 522. Client device 522 can exchange data with the diagnosis and maintenance system 302 via device interface component 318, which may comprise a wired or wireless network interface, a near-field communication interface, an external network connection such as an internet connection, or other such device interface suitable for the particular platform on which the search system is implemented. In some embodiments, device interface component 318 may be configured to verify an authorization of the client device 522 to access the search system prior to allowing search queries to be submitted by the client device. The device interface component 318 may authenticate the client device or its owner using password verification, biometric identification, cross-referencing an identifier of the client device with a set of known authorized devices, or other such verification techniques.

In some embodiments, the device interface component 318 may be configured to serve an interface display or dashboard to the client device 406 when the client device requests access to the system 302. The interface display can include interface elements that allow the user of client device 522 to manually enter and submit a search query 602 to the system 302. For example, the display may allow the user to enter a keyword, term, or phrase as a search criterion. Example search terms may include identifiers of specific devices or machines, names of production areas within one or more of the plant facilities 520, product names or codes, employee names, or other such criteria.

In addition to manually entered search criteria, some embodiments of the device interface component 318 can be configured to translate barcodes or Quick response (QR) codes affixed to devices or machines. For example, a user may scan or photograph a barcode or QR code attached to a device, machine, or product (e.g., a pin-stamped or laser-etched barcode affixed to a workpiece during the production process) using client device 522, wherein the barcode contains identification information about the associated component. The client device 522 can then submit identification information extracted from the barcode to the device interface component 318 as a search criterion. In yet another example, client device 522 may extract information about an industrial device or its associated process directly from the device via near field communication (NFC) and submit the extracted information to the device interface component 318. This extracted information can include, but is not limited to, a device identifier, device status information read from a status word maintained on the industrial device, alarm data extracted from an alarm register, production statistics stored on one or more data tags, or other such information.

Upon receipt of search query 602, device interface component 318 routes the query to search component 310, which searches federated data model 202 for content relevant to the search query. Search query 602 may comprise, for example a data tag name (e.g., Tank1), a product identifier (e.g., for conducting searches for aggregated product statistics across all facilities 520), a device or machine attribute, a device vendor, a name of a particular area of the industrial environment (e.g., a workcell or production line), a product name or identifier, or other such search criteria. Search component 310 searches the federated data model 202 for the search criteria identified by the search query 602, identifies data items corresponding to the search criteria, and returns a list of search results 604 to the client device 522 via device interface component 318. Since the search results 604 may correspond to data items found on multiple disparate platforms throughout the plant environments (e.g., industrial controllers, HMIs, device documentation repositories, etc.), the device interface component classifies the results according to the platforms on which the results were found, location of the results within the plant environment (e.g., production area, workcell, etc.), or other classification criteria.

In addition to processing search queries submitted by the user via a client device (or in association with such search queries), the diagnosis and maintenance system 302 can also perform cross-facility analysis on the data model 202 and generate statistics or recommendations based on results of the analysis. To this end, system 302 can include an analysis component 314 configured to perform such analysis on data model 202. For example, analysis component 314 may compare performance metrics across similar automation systems (e.g., controlled machines, production lines, workcells, etc.) at different plant facilities, and correlate the relative performance metrics with variations in the ways those automation systems are designed, programmed, or configured. Based on results of these comparative metrics and correlations, the analysis component 314 can identify a design, program, or configuration that achieves the best performance, and generate recommendations for modifying other automation systems to achieve similar optimized performance. Since some embodiments of data model 202 can also record operator workflow information, the analysis component 314 can also correlate machine or system performance with operator workflows, and generate a suggested workflow to be adopted at all facilities in order to achieve best results.

In some scenarios, these types of comparative analyses can be performed by the system 302 in response to a request from client device 522. For example, the user may access the cloud-based diagnostic and maintenance services via client device 522 and request a cross-facility assessment relative to a specified type of machine and/or performance metric. In response to this request, the analysis component 314 will perform the requested cross-facility analysis and return the requested diagnostic analysis results 606 to the client device.

In other scenarios, the analysis component 314 may be configured to perform automatic, periodic cross-facility analysis on federated data model 202, and generate recommendations or notifications in response to determining that the analysis results satisfy a defined notification criterion. Such notification criteria may include, for example, a determination that a machine, production line, or facility having a performance metric (e.g., product output, product quality, energy consumption, machine downtimes, revenue, etc.) that has fallen below that of the other machines, lines, or facilities by a defined degree. These types of comparative analytics will be described in more detail below.

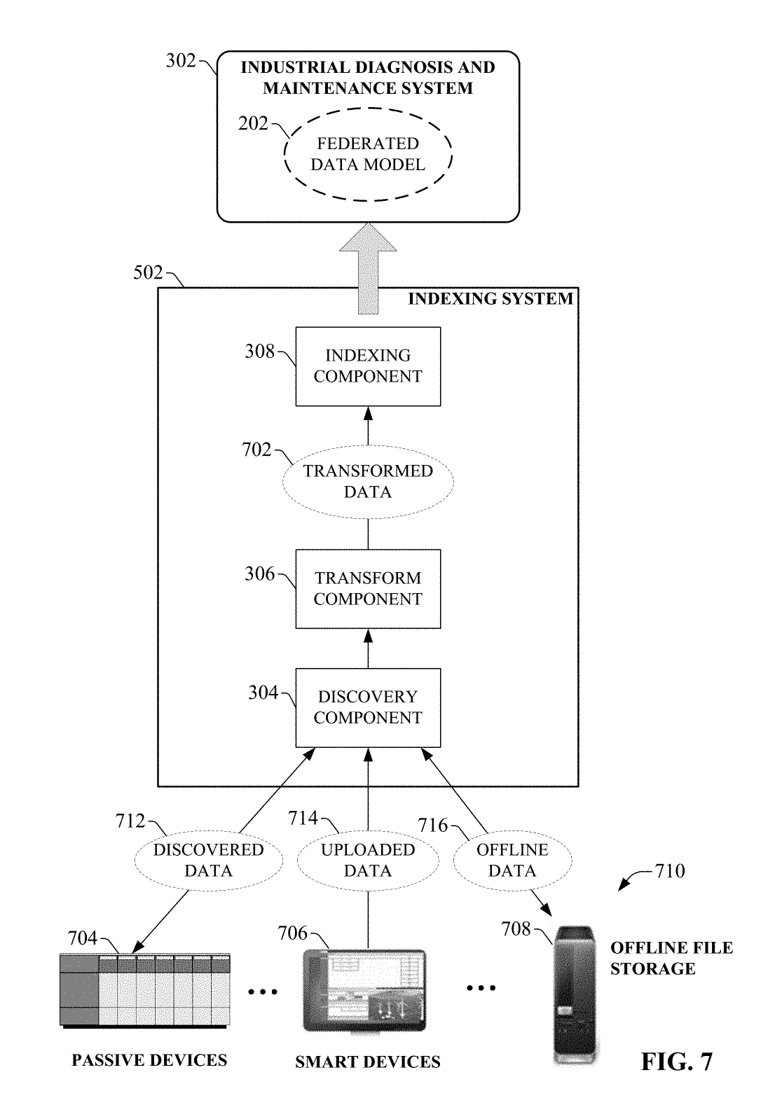

FIG. 7 is a block diagram that illustrates processing performed by the industrial data indexing system 502. Each industrial environment corresponding to the respective facilities 520 may comprise a diverse, heterogeneous set of data sources 710. In order to unify the data available on these sources under a common namespace for search purposes, the discovery component 304 can be configured to discover data in a number of ways. Some devices within the plant environment may be passive devices 704, which only provide information regarding their available data items in response to a request from the discovery component 304 of the indexing system 502. Such a request may be initiated by the discovery agent 518 (see FIG. 5).

In an example scenario, when the discovery agent 518 discovers a new data source during traversal of the plant network, the agent will examine the data source to identify the data items on that device that are eligible for indexing in the federated data model 202. If the discovered data source is an industrial controller, for example, the available data items may comprise data tags or registers defined by the industrial controller's configuration and programming file. The discovery agent can also identify how and where the data items are used in the industrial controller's program (e.g., ladder logic, sequential function chart, structured text, etc.) so that this information can be indexed as well. For example, upon discovery of the industrial controller on the plant network, the discovery agent 518 may subsequently identify a tag named Tank1 defined in the controller's program file, representing a particular tank of an industrial batch process. In response to discovering this tag, the discovery agent can scan the control program to identify the routines and program locations (e.g., ladder logic rungs) on which Tank1 is referenced. The discovery agent 518 can also identify how each instance of Tank1 is used at each program location (e.g., output coil, normally open contact, function block argument, etc.).

The discovery agent may additionally identify other data items defined in the industrial controller that have a functional relationship with Tank1. For example, upon identifying a reference to Tank1 on an output coil of a rung of the control program running on the industrial controller, the discovery agent 518 can then identify the other data values and statuses defined on that rung that control the state of the Tank1 output coil, and record this relationship between Tank1 and each of the other data values and statuses. In some embodiments, the discovery agent 518 can perform additional scans of the control program to determine additional data values and statuses that affect the states of each of the related data items, since those additional data values/statuses also affect the status of the Tank1 output coil. The discovery agent 518 may iteratively cycle through the control program multiple times in this fashion in order to discover all relevant data items having a functional relationship with Tank1.

In another example, the discovered data source may be an interface terminal executing an HMI application for visualizing a controlled process. In this scenario, the discovery agent may identify the terminal and proceed to scan the tag list defined in the HMI application to identify the data tags referenced by the HMI. These data items can include HMI tags linked to data tags of a networked industrial controller for display of associated controller data values or statuses on one or more of the HMI screens, or for writing values to the controller tags via an input object rendered on an HMI screen (e.g., a data entry field, a virtual push-button, etc.). For each discovered HMI tag, the discovery agent can identify the display screens on which the HMI tag is registered, as well as the external controller tags corresponding to the HMI tag. In some scenarios, the HMI tag may be identified by the same name as the corresponding controller tag (e.g., Tank1), although this may not always be the case.

The discovery agent 518 can package the information collected as described above—including an identity of the data source and its type (e.g., industrial controller, HMI, knowledgebase, device documentation, etc.), data items discovered on the data source, locations of the data items within an application running on the data source (e.g., routine and rung of a ladder logic program, HMI screen, etc.), correlations between the data items, etc.—and send this information back to the discovery component 304 as discovered data 712. Since the discovery agent 518 is capable of performing appropriate analysis on a number of different types of data platforms (e.g., industrial controller, HMI, device documentation, etc.) in order to identify the data platform and its available data, the discovery agent 518 may pre-format the discovered data 712 to conform a format compatible with the diagnosis and maintenance system 302 prior to returning the discovered data 712 to the discovery component 304. In this way, the discovery component 304 and its associated discovery agent can automatically normalize heterogeneous data from diverse data formats into a common, homogeneous format that can be collectively processed and indexed by the indexing system.

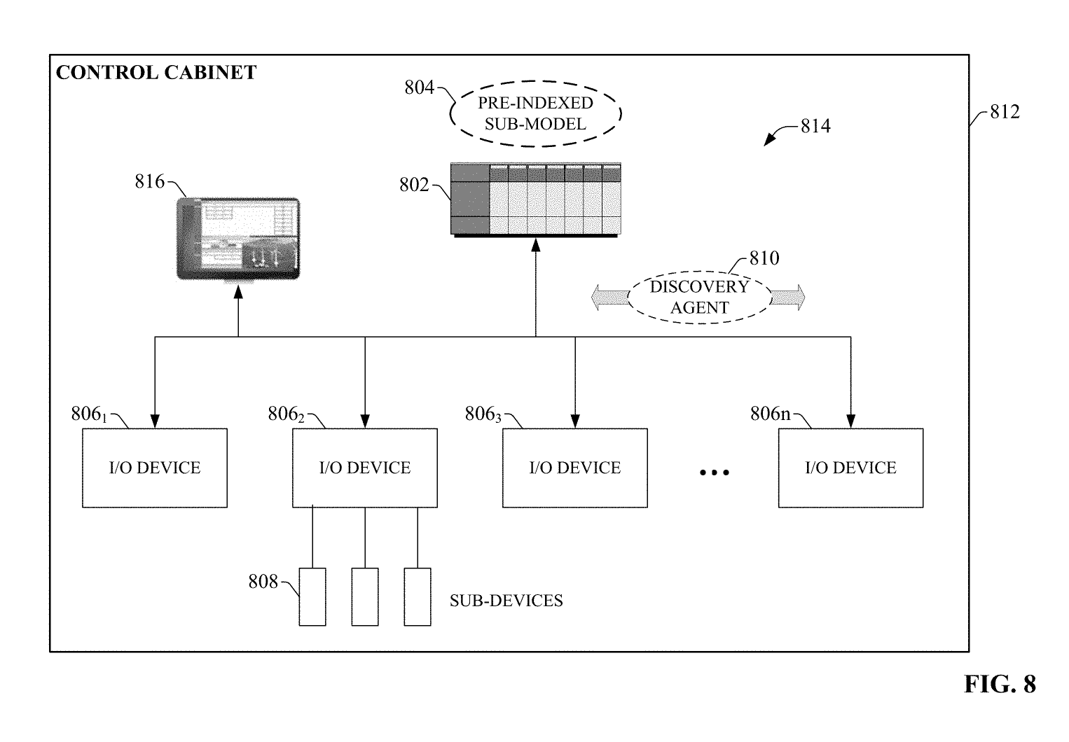

While the previous examples described the discovery agent as being deployed by a discovery component of a centralized indexing system that is part of a multi-platform diagnosis and maintenance system, some sub-systems within a customer's larger plant environment may be pre-discovered prior to deployment within the larger industrial enterprise. For example, in some embodiments the indexing system may be implemented on an industrial device, such as an industrial controller, which deploys a discovery agent to discover devices and data that reside under that device (e.g., devices that are controlled by, or provide data to, the industrial controller), as well as the configurations, data, and interdependencies associated with these devices. FIG. 8 is a diagram illustrating creation of a pre-indexed sub-model 804 using indexing functionality implemented on an industrial controller 802. In this example, industrial controller 802 is mounted in a control cabinet 812 as part of a control system 814 to be installed at a plant facility. The control system 814 is housed in control cabinet 812, which may have been designed and built by an original equipment manufacturer (OEM), a systems integrator, or other machine builder to fulfill a customer order.

Control system 814 may comprise a number of I/O devices 806 (e.g., motor drives, sensors or other telemetry devices, solenoid valves, remote I/O modules, etc.) interfaced with the industrial controller 802. The I/O devices 706 may be hardwired to the industrial controller's I/O modules, or may exchange data with the industrial controller 802 over a local network (e.g., EthernetIP, common industrial protocol, etc.). In addition, one or more of the I/O devices 806 may have a number of sub-devices 808 connected thereto. For example, if an I/O device is a remote I/O module, sub-devices 808 may comprise the I/O devices connected to that remote I/O module. The control cabinet 812 may also include an HMI terminal 816 for visualizing the machine or process being controlled by the control system 814. The HMI terminal 816 is communicatively connected to the industrial controller 802 over a local network connection or an interface cable. Industrial controller 802 may comprise any standard controller capable of executing industrial control programming (e.g., a PLC or other type of programmable automation controller), or may be a composite device that supports both PLC functionality as well as personal computer (PC) operating system functionality (e.g., Windows or another operating system). In the latter scenario, the PC operating system functionality of the controller 802 may be used to execute the indexing functionality described herein.

Since industrial controller 802 is implemented with indexing functionality, the controller can pre-discover the available devices and data within the control cabinet 812 before the control system 814 is installed at the customer facility. For example, the indexing system can examine the controller's configuration, tag list, and programming information to identify some or all of the I/O devices 806 and sub-devices 808 connected to the controller, data items that are available on the controller, the location of the data items within the controller's program routines, interdependencies between the data items, etc. In addition, the industrial controller 802 can deploy a discovery agent 810 on its local network to discover additional devices and available data below the controller level. For example, the discovery agent 810 can identify the HMI terminal 816 connected to the industrial controller 802, identify the available data tags defined by the HMI application running on the terminal as well as the interface screens on which each data item is referenced, correlations between one or more of the HMI tags and corresponding tags defined in the industrial controller 802, etc. The discovery agent 810 reports this information to the indexing system on the industrial controller 802 for indexing.

In a similar fashion, the discovery agent 810 traverses other accessible devices below the controller level and reports discovered devices and data back to the controller's indexing system. In this regard, some I/O devices 806—particularly those I/O devices that are hardwired to the industrial controller's I/O modules—may be discoverable without deploying discovery agent 810 by simply examining the I/O module configuration information defined on the industrial controller, since this I/O module configuration information specifies the devices connected to each point of the I/O modules. For I/O devices that are networked to the industrial controller 802—which may include devices capable of operating autonomously or semi-autonomously and which may contain additional data items that are not made available to the industrial controller 802 (e.g., vision systems, barcode stamping systems, barcode reader systems, etc.)—the discovery agent 810 can discover and analyze these devices and report the available data items back to the controller's indexing system.

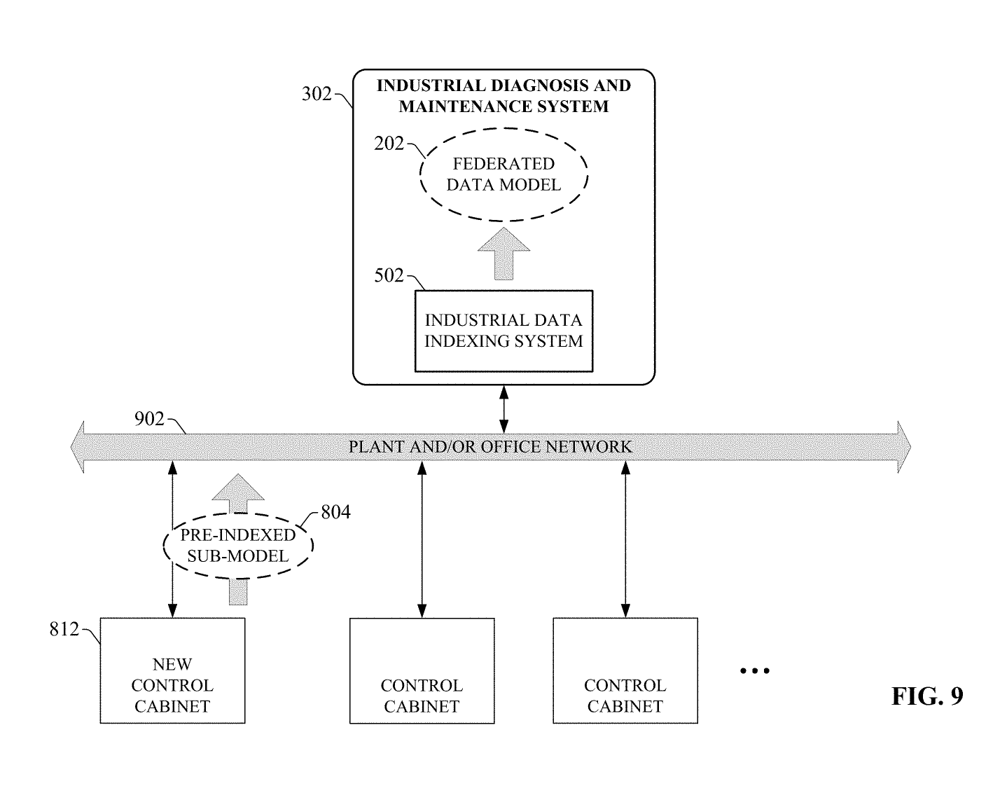

The industrial controller 802 leverages the discovered data to generate a pre-indexed sub-model 804, which represents the control system 814 and its available data. As illustrated in FIG. 9, when the control cabinet 812 is installed at the customer facility, the industrial controller 802 establishes communication with the pre-existing industrial data indexing system 502 over plant network 902 and sends the pre-indexed sub-model 804 to the indexing system 502 for integration with the customer's existing federated data model 202. By implementing an indexing system on an industrial device, a machine builder can provide a machine and associated control system with its portion of the namespace model pre-discovered and indexed as a sub-model, which can be quickly integrated with the customer's larger plant model.

Although the example described above in connection with FIGS. 8 and 9 depicts the indexing functionality as being implemented on an industrial controller, this functionality can also be implemented on other control system devices, including but not limited to an HMI, motor drive, or other device.

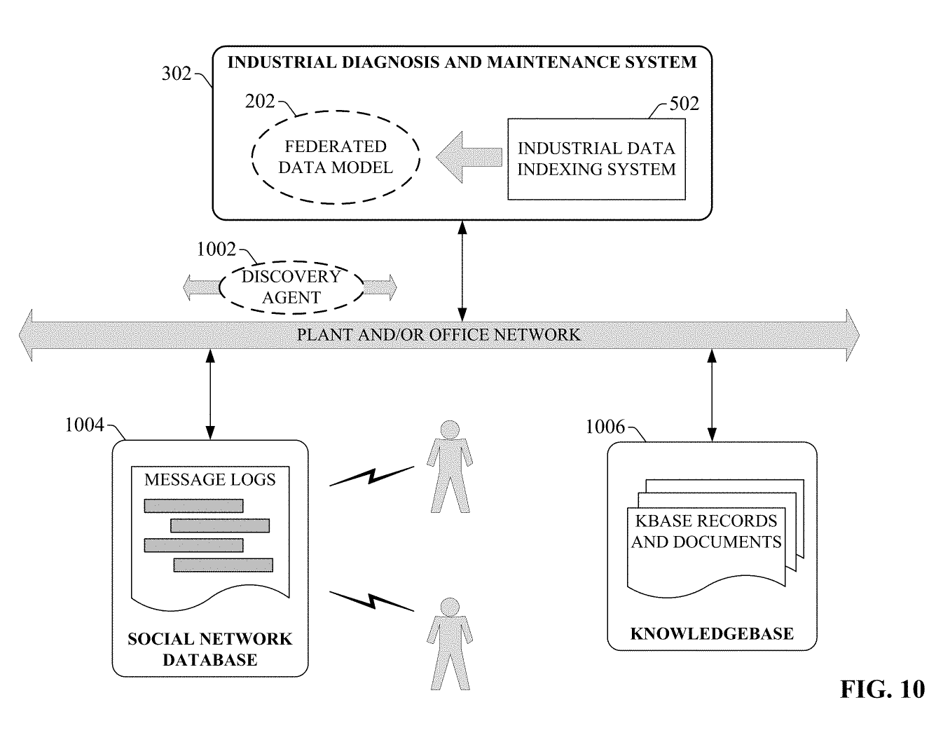

In some embodiments, the discovery agent may also be configured to examine social networks used by plant employees in order to generate tags based on instant messaging discussions relating to a project or troubleshooting issue. FIG. 10 is a diagram illustrating an architecture in which discovery agent 1002 collects and indexes message log information. In this example, a social network database 1004 stores written communications between plant personnel. The written communications may comprise instant message logs, e-mail threads, text records, or other communication records. During data discovery, the discovery agent 1002 can identify the social network database 1004 and parse the stored message logs for keywords that may be used to associate the message logs with a particular work area, machine, process, or device. For example, the discovery agent 1002 may determine, based on discovery of particular keywords within a message log, that a particular stored conversation was generated in connection with troubleshooting a particular machine or industrial device. Accordingly, the discovery agent 1002 can report the presence of the message log to the discovery component with an instruction to tag the message log as being relevant to the machine or device. In this way, when a subsequent search is performed on the federated data model 202 for the machine or device, the message log will be returned as a relevant result. These logs may detail steps taken by maintenance personnel in connection with solving a particular issue with the machine or device, and are therefore flagged by the system as a relevant result when a search is performed on that machine or device.

In some embodiments, the discovery agent 1002 may associate relevant supplemental information with a discovered message log based on keyword analysis of the log. For example, the customer may maintain a knowledgebase 1006 on the plant or office network containing knowledgebase records and/or device documentation relating to particular devices or maintenance issues. Upon determining that a message log relates to a troubleshooting session for a particular machine or device, the discovery agent 1002 (or discovery component 304) may generate an association between the log and a knowlegebase record or device document relating to that machine or device. Thus, when a search is subsequently performed for the machine or device, the search system can present a message log outlining steps taken in the past to address a maintenance issue pertaining to the machine/device, with links to relevant knowledgebase articles or device documents to provide supplemental information.

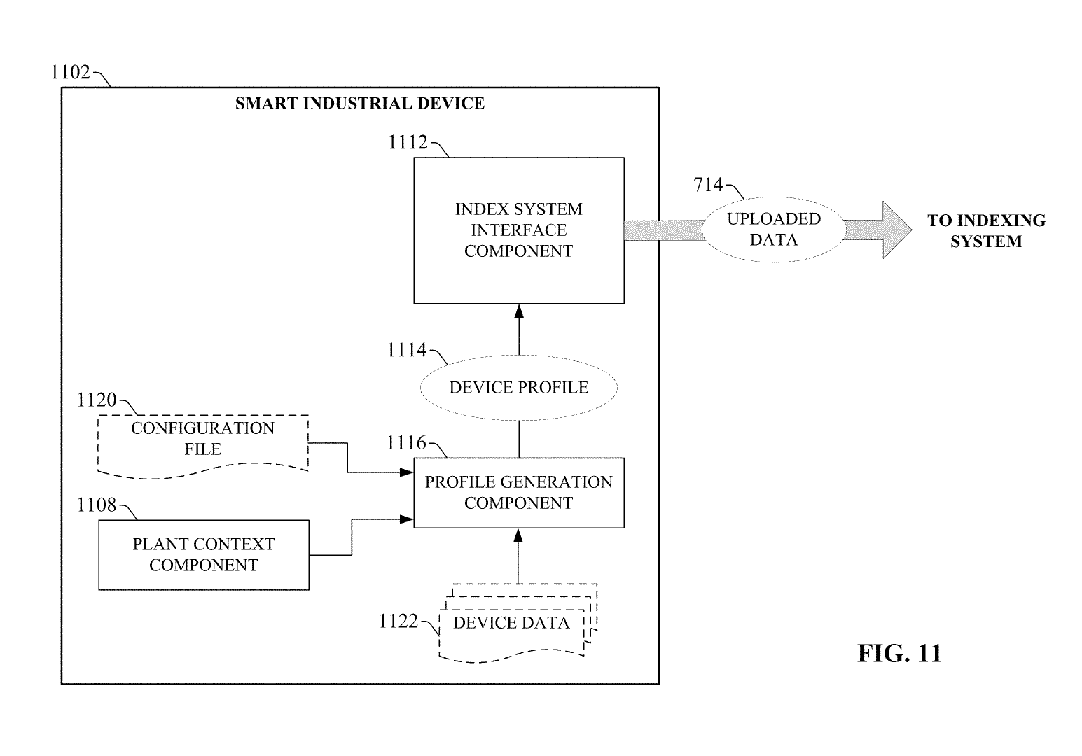

Returning now to FIG. 7, in addition to passive devices 704, the industrial environment may include one or more smart devices 706 having integrated self-reporting functionality. Such devices can provide uploaded data 714 regarding their identity and available data items to the indexing system 502 directly without the need for analysis by a discovery agent. Turning to FIG. 11, an example smart device capable of self-reporting to indexing system 502 is illustrated. Smart device 1102—which may comprise substantially any type of industrial device or data storage unit (e.g., an industrial controller, an HMI terminal, a motor drive, device documentation storage, etc.)—includes an index system interface component 1112 configured to communicatively couple smart device 1102 to the indexing system 502 and exchange data therewith; e.g., via a plant network or over a public network such as the Internet (for configurations in which the indexing system resides on a web server or cloud platform).

When smart device 1102 is installed as part of an industrial automation system, index system interface component 1112 can establish communication with the indexing system 502. In one or more embodiments, the index system interface component 1112 can be configured to auto-discover the indexing system 502 on the common network. For example, the smart device 1102 may be pre-configured with the identification of the indexing system to which the device is to provide its identity and configuration information (e.g., a name associated with the indexing system, a machine identifier, a cloud or web address, etc.), or may be configured to perform a search of the plant network for compatible industrial indexing and search systems that may be present on the network. Any suitable handshaking protocol may be used to establish communication between the smart device 1102 and the indexing system.

Upon discovery of the search system, the smart device 1102 can package and send relevant information about the device and its available data to the indexing system, which integrates the reported data items in federated data model 202. In some embodiments, a profile generation component 1116 can generate a device profile 1114 for smart device 1102 to be sent to the indexing system 502 via index system interface component 1112. Device profile 1114 can convey information about smart device 1102, including but not limited to an identity and type of the device, device data 1122 available on the device, a context of the device within the industrial environment, any built-in displays or dialog screens (e.g., HTML pages) that provide access to the device's data, etc. In some embodiments, profile generation component 1116 may collect configuration information encoded in a configuration file 1120 stored on the smart device 1102, which may be a control program, a configuration or parameters settings file, an application file (e.g., an HMI application or HTML page), or other such file. The profile generation component 1116 can also identify available device data 1122 on the device (e.g., real-time or historical data tags, etc.). In some embodiments, the profile generation component 1116 can also identify relationships between the data items using techniques similar to those used by the discovery agent, including but not limited to the iterative relationship discovery process described above. The profile generation component 1116 can package this information into a device profile 1114, which is then sent to the indexing system as uploaded data 714 by index system interface component 1112.

Some embodiments of smart device 1102 may also include a plant context component 1108 configured to collect additional contextual information about the smart device 1102 for delivery to indexing system 502. Plant context component 1108 can determine a context of smart device 1102 within the plant or enterprise environment. For example, one or more embodiments of plant context component 1108 can identify other devices and systems within its local environment and make a determination regarding a location of smart device 1102 within a hierarchical plant context or device topology. Some embodiments of the federated data model 202 may represent a given industrial enterprise in terms of multiple hierarchical levels and device hierarchies, where each level comprises units of the enterprise organized as instances of types and their properties. For example, a given data item may be tagged in the data model 202 with hierarchical location data identifying the location of origin of the data item in terms of the following increasingly granular hierarchical levels—a plant facility, a work area within the facility, a production line within the work area, a machine within the production line, and a device associated with the machine. These levels are only intended to be exemplary, and it is to be appreciated that other combinations of hierarchical levels are within the scope of one or more embodiments of this disclosure.

Plant context component 1108 can gather information that facilitates locating its associated smart device 1102 within an organizational or device hierarchy in a number of ways. In one example, plant context component 1108 can identify a topology of devices sharing a common network with smart device 1102 and interconnections between the devices. For example, if smart device 1102 is an industrial controller, plant context component 1108 can identify one or more discrete or analog I/O devices connected to the controller (e.g. based on a configuration file 1020 that defines the I/O module configurations for the controller). In addition, plant context component 1108 can identify other controllers on the network and their role within the overall industrial enterprise (e.g., the production areas, workcells, or processes associated with the respective controllers). In some embodiments, plant context component 1108 can also determine an identity of a particular network (e.g., a network name) to which smart device 1102 is attached. This information can be leveraged (either by profile generation component 1116 or an external application) to determine the device's location and role within the industrial enterprise, since some networks may be dedicated to a particular production area. Some embodiments of plant context component 1108 may also identify a type of machine to which smart device 1102 is connected (e.g., a palletizer, wrapper, conveyor, etc.).

By gathering information about the local device topology, plant context component 1108 can facilitate identifying a location of smart device 1102 within the enterprise hierarchy. In some embodiments, this determination of the location within the enterprise hierarchy can be made by plant context component 1108 itself. Alternatively, profile generation component 1116 can include information gathered by plant context component 1108 in device profile 1114 so that the indexing system 502 can accurately represent smart device 1102 within the enterprise or device hierarchy.

Some smart devices may also store pre-defined interface screens (e.g., HTML screens) used for device configuration or visualization of operational data. The indexing system can detect these screens (either using the discovery agent or based on information in the device profile 1114 provided by the device) and index these screens in the federated data model 202.

Returning to FIG. 7, the indexing system 502 may also collect and index offline data about certain industrial devices rather than gather information about the devices directly from the devices themselves. In this regard, some industrial devices may have information about their configuration, programming, and available data items captured and stored as offline files stored on separate offline file storage devices 708. Accordingly, one or more embodiments of the discovery agent 518 can identify and process these offline files in a similar manner as described above in order to index these devices in the federated data model.

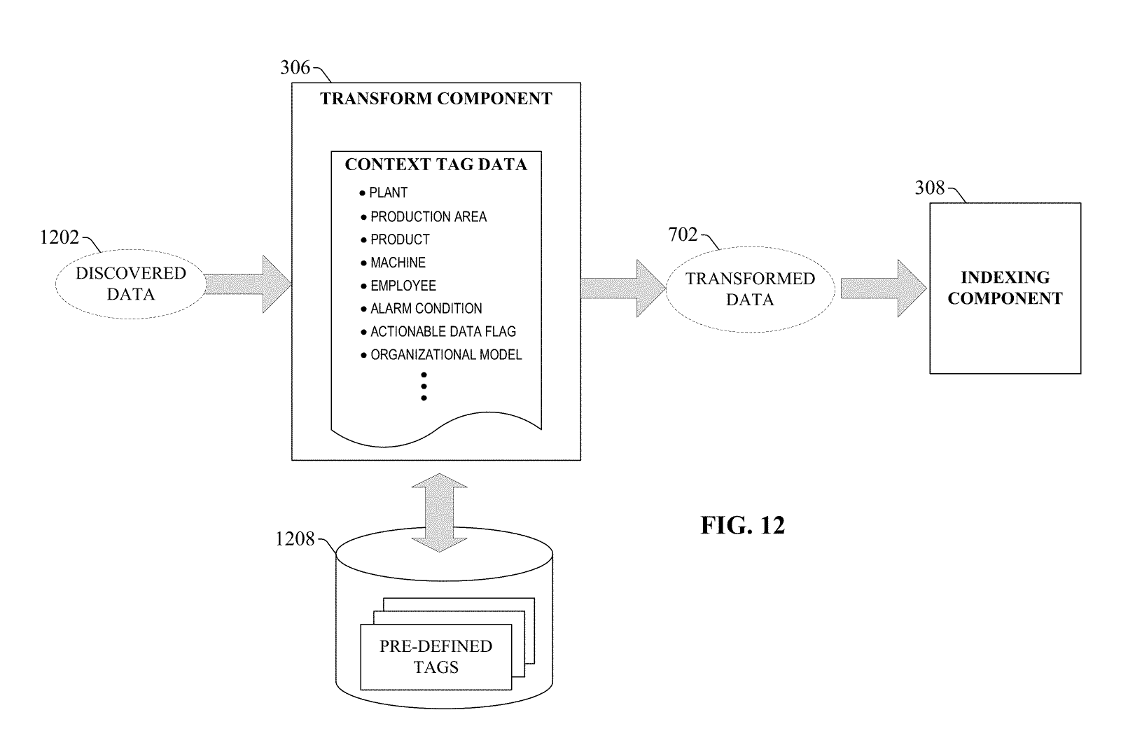

Transform component 306 can perform any necessary transformation on the data collected by discovery component 304 prior to indexing. This can include, for example, normalizing any data that was not appropriately formatted by the discovery agent 518, so that all collected data accords to a common format usable by the indexing system 502. In some embodiments, transform component 306 can also add contextual data or tags to the collected data items to achieve highly granular indexing for search purposes, as well as to facilitate subsequent discovery of interdependencies between the diverse and plant-wide data items. FIG. 12 is a block diagram illustrating transformation of discovered data 1202 by transform component 306. As noted above, the discovery agent 518 (or discovery component 304) may add some contextual information to the discovered data items prior to sending the data to transform component 306. However, in some cases the transform component 306 may be able to add additional context to this data based on information not available to the discovery agent 518. In other scenarios, the discovery agent 518 may not have been able to contextualize all the discovered data due to limited available information about a given device (e.g., in the case of an older legacy device with limited capabilities).

Contextual data that can be added by transform component 306 for a given data item can include, but is not limited to, an identifier of a plant and/or production area at which the source of the data item resides; a machine or product to which the data item relates; one or more employees to be associated with the data item (e.g., based on the production area, shift during which the data item was collected, etc.); a concurrent alarm condition determined to be relevant to the discovered data item; an actionable data flag indicating that the value of the collected data item requires a response from plant personnel; or a tag indicating the location of the data time within the context of a hierarchical organizational model of the plant (e.g., in terms of an enterprise level, plant level, work area level, machine level, control level, etc.).

In some embodiments, the transform component 306 can selectively tag discovered data items with one or more pre-defined tags 1208 defined in association with the indexing system 502. These tags may be used to contextualize the discovered data based on one or more user-defined tag categories based on tagging rules. For example, the user may define a tagging rule indicating that data collected from data sources within a particular workcell or machine of the plant are to be tagged with a pre-defined tag that associates the data items with a person, product, or other classifier for indexing and searching purposes. The tags 1208 allow the user to define relationships between sets of data that may not be automatically discoverable by the discovery component 304 and its associated discovery agents. In some embodiments, the indexing system may also be configured to maintain a user-defined system view that allows a user to selectively associate different devices under a combined unit of organization. This user-defined association can subsequently be used by the search system to ensure that all relevant devices are located in response to a search query. For example, when one device (and its associated data) is located within the logical hierarchy of the system defined by the federated data model in response to a search query, other devices having a user-defined association with the located device will also be identified and retrieved as a relevant search result. In some embodiments, these user-defined associations may also be made between selected data items stored on different devices (data-level associations), as well as between the device's themselves (device-level associations).

In some embodiments, the transform component 306 may also auto-generate tags for a given data item based on contextual information, including but not limited to rung comments associated with a controller tag, learned interdependencies between a newly discovered data item and a previously discovered data item (e.g., learn that Pump5 is associated with Tank1, and tag Pump5 as being associated with Tank1, or tag both Tank1 and Pump5 according to the larger system in which they operate), or other discovered contextual information. The indexing component 308 can associate similarly tagged data items in the federated data model 202 regardless of the platform in which they were discovered. For example, the indexing component 308 can associate common or related data items discovered, respectively, in an industrial controller, an HMI, and a data historian.

Returning now to FIG. 7, the transform component 306 provides the transformed data 702 to indexing component 308, which indexes the discovered data and interdependencies therebetween in federated data model 202. The industrial diagnosis and maintenance system 302 can then perform cross-facility analysis on the data model for diagnostic, maintenance, or optimization purposes as described above, as will be described in more detail below.

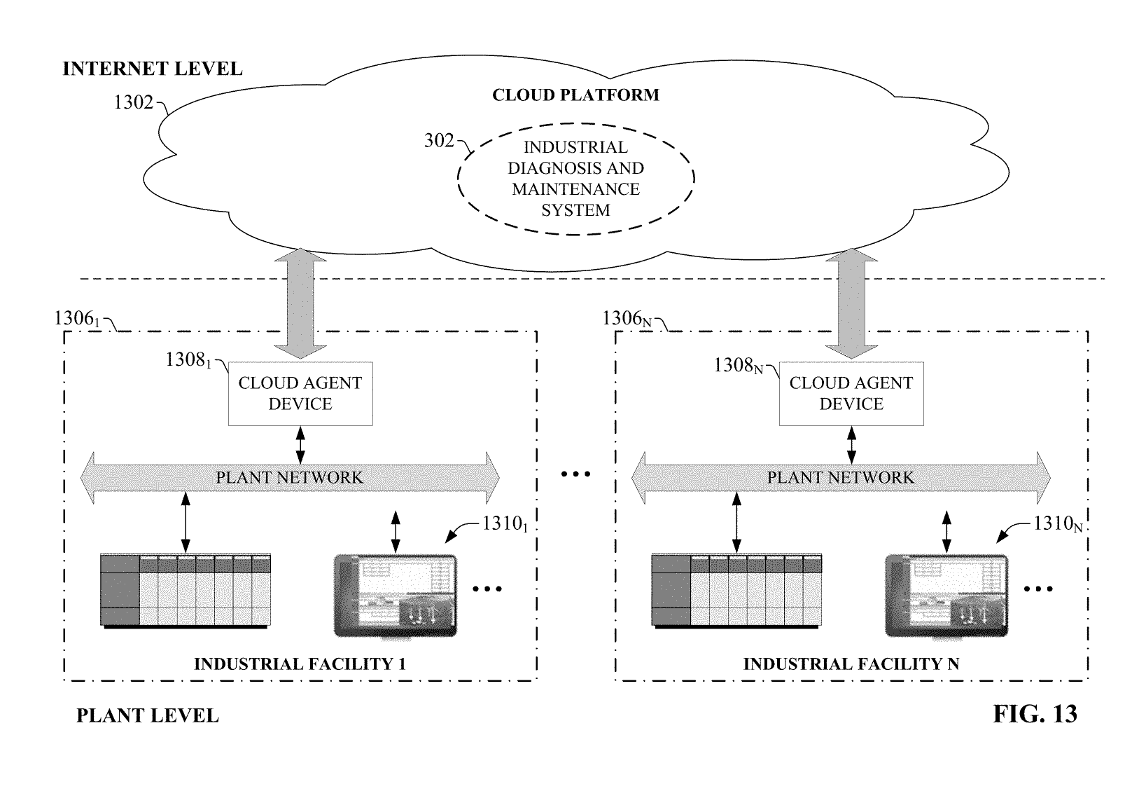

Although the examples described above have depicted the industrial data being retrieved from the industrial devices by the discovery agent under the supervision of discovery component 304, or being pushed to the cloud-based system by smart industrial devices, in some embodiments at least a portion of the uploaded data may be provided to the diagnostic and maintenance system 302 by proxy devices or cloud agent devices. FIG. 13 is a conceptual diagram of a generalized implementation that uses cloud agent devices 1308 on the plant floor to collect and push industrial data to the diagnosis and maintenance system for indexing.

Cloud agent devices 1308 are installed on the respective plant networks at the industrial facilities 1306, thereby networking the cloud agent devices to other industrial devices 1310 residing on the networks. Cloud agent devices 1308 collect selected subsets of data from the industrial devices 1310 and send the data to the indexing system 502 of the diagnosis and maintenance system 302. If cloud platform 1302 is a web-based cloud, cloud agent devices 1308 at the respective industrial facilities 1306 may interact with diagnosis and maintenance system 302 directly or via the Internet. In an example configuration, the industrial devices 1310 may connect to the on-premise cloud agent devices 1308 through a physical or wireless local area network or radio link. In another example configuration, the industrial devices 1310 may access the cloud platform 1302 directly using integrated cloud agent services.

With data from multiple industrial facilities brought together under the cloud-based federated data model 202, searches submitted to the data model (e.g., via the device interface component 318 and implemented by the search component 310) can return results from multiple plants, and aggregate these results as needed, depending on the nature of the search. This can be particularly useful for searches performed from the corporate level of the industrial enterprise. For example, since the federated data model 202 may maintain inventory information a given product or part for each facility, a user may submit a search requesting a total, enterprise-wide inventory level for the product or part. The device interface component 318 can return this total inventory information via a graphical interface that also allows the user to view the inventory information at different levels of granularity. For example, the interface may allow the user to select an enterprise-level inventory view (e.g., a total inventory for the enterprise), or a facility-level inventory view that shows the inventory levels at each facility.

Similarly, the user may submit a request for performance statistics to the system 302, where such performance statistics may include production rate, production volume, machine downtime statistics, energy consumption or efficiency statistics, product quality statistics, or other such metrics. Since the data model 202 links such statistics from multiple facilities under a common namespace, the diagnostic and maintenance system 302 can retrieve and return the requested performance statistics for the enterprise as a whole, as well as providing an option to view the performance statistics for individual facilities or production areas.

By virtue of the multi-facility data model 202, the analysis component 214 can also perform comparative metrics across the various facilities 520, as well as between production lines, machines, or devices in use throughout the enterprise. In an example embodiment, a user may enter a request for comparative metrics to be performed across a set of similar automation systems (e.g., machines, production lines, workcells, collections of industrial devices that carry out a common manufacturing task, etc.) that carry out a common manufacturing task. The common task may be, for example, production of a particular product or part specified by the user, execution of a specified industrial process (e.g., a batch process for producing a food or drug), execution of a die casting or molding process for producing a specified engine block model, etc. In response to the request, the analysis component 214 can identify subsets of the indexed data stored in the data model 202 that correspond to the relevant automation systems. The identified subset of data may correspond to similar automation systems located across multiple facilities that carry out similar tasks or processes, and may represent a range of statistics and metrics for the respective automation systems, including but not limited to product throughput, product quality statistics, system downtime statistics, the amount of time each system spends in respective operating modes (e.g., running mode, idle mode, abnormal mode, etc.), energy consumption statistics for the respective automation systems, the rate at which each industrial system consumes material resources, or other such statistics. The subset of identified data can also include information regarding the architecture and configuration of the respective automation systems, including but not limited to the industrial devices (e.g., vendor and model) that make up the automation systems, software configurations for the respective industrial devices (e.g., configuration settings, control loop tuning parameters, firmware revisions, controller programming code, etc.), or other such information.

Other information stored in the model that is extrinsic to the automation systems but related to the processes carried out by the systems is also identified. This extrinsic information may include, for example, operator workflows (e.g., monitored operator actions that are routinely performed in connection with carrying out the process, operating standards that were obtained from electronic standard operating procedure documentation stored at the respective facilities, etc.), maintenance schedules for the respective automation systems, etc. Some of this extrinsic information may be derived by the system 302 by monitoring operator activity with respect to each automation system. For example, the indexing system 502 may be configured to indirectly monitor operator interactions with a given automation system by observing which control panel and/or HMI controls are selected or set, and the order in which the controls are selected, in response to various machine states or conditions. The system 502 may also monitor the operator interactions by which the operator places the automation system in particular operating modes. By indexing the sequence of machine interactions in the federated data model 202, the system 302 can identify sequences of operations that are repeatedly carried out by operators of the respective automation systems in response to various conditions (e.g., the sequences carried out by the operator to recover from a particular abnormal mode, the sequences carried out to transition the automation system to run mode, etc.). In addition, some of this extrinsic information can be obtained by the system 302 from electronic standard operating procedure documents stored at the respective facilities. For example, such documents may identify prescribed operator workflows to be carried out to achieve various identified goals (e.g., abnormal recovery, reconfiguring a machine to run a different specified product type, etc.). The indexing system 502 can index this information in the federated data model 202 in association with the automation system to which it relates for analysis purposes.

Once this relevant subset of data is identified, the analysis component 214 can perform comparative analysis on the performance metrics for the respective industrial systems, and correlate results of the comparative analysis with detected variations in the system configurations. In this way, the analysis component 214 can identify which of the similar automation systems achieves the best performance relative to a performance metric specified by the user (e.g., energy consumption, product throughput, total runtime, etc.), and make a determination regarding which system configuration aspects are most relevant to achieving the superior performance.

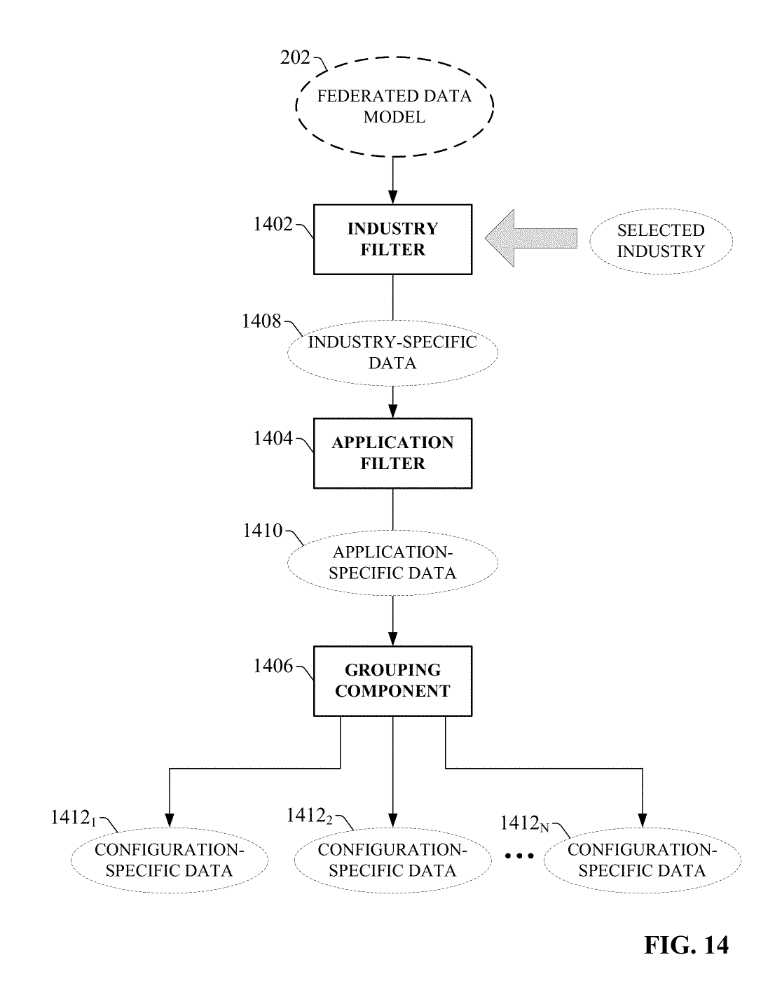

FIG. 14 illustrates an example data processing technique that can be implemented by the analysis component 214 to facilitate industry-specific and application-specific comparative analysis across multiple automation systems. In this example, analysis component 214 may comprise an industry filter 1402, an application filter 1404, and a grouping component 1406. A user may wish to compare performance metrics for different industrial asset configurations that perform a common industrial application (e.g., a particular pharmaceutical batch process, automotive die casting process, etc.). The industry filter 1402 may be useful in embodiments in which federated data model 202 includes data collected and indexed from industrial enterprises or facilities that related to multiple different industries or verticals (e.g., food and drug, plastics, oil and gas, automotive, etc.). Since similar sets of industrial devices may be used to carry out similar applications in different industries or verticals, the analysis component 214 can identify subsets of data that were collected from systems in the relevant industry and indexed in data model 202. This can yield more accurate analysis results, since a given industrial asset configuration—comprising a particular set of industrial devices, firmware revisions, etc.—may demonstrate different behavior depending on the industry or vertical in which the asset is used.

Accordingly, industry filter 1402 identifies a subset of the data stored in model 202 that was collected from industrial assets in the relevant industry. The relevant subset of industry-specific data can be identified, for example, based on information in a customer model (not shown) associated with the user of the diagnosis and maintenance system 302, which can identify the industry or vertical with which the user is associated. Alternatively, if the user is associated with an enterprise that owns facilities in multiple different types of industries, the user may specify a selected industry for analytical purposes.

The industry-specific data 1408 comprising the subset of model data relating to the industry of interest can then be filtered by application filter 1404, which identifies a subset of the industry-specific data 1408 relating to a particular industrial application (e.g., a specific batch process, motor control application, control loop application, barcode tracking application, etc.) within that industry. The resulting application-specific data 1410 comprises data (e.g., operational data, abnormal or downtime data, product throughput data, energy consumption data, etc.) collected from multiple industrial assets at different industrial enterprises that perform the specified industrial application within the industry of interest. The industrial assets represented by application-specific data, while carrying out a common industrial application, may comprise different asset configurations (e.g., different device combinations, different software code, different firmware versions or operating systems, etc.).

In order to identify trends or operating characteristics as a function of the different asset configurations, grouping component 1406 can segregate application-specific data 1410 into groups of configuration-specific data 1412. Grouping component 1406 can group the data according to any suitable asset configuration variable, including but not limited to device model, device configuration settings, firmware version, software code executed on one or more industrial devices comprising the industrial assets, or other variable asset characteristics. Grouping the application-specific data in this manner results in N groups of data, where each group comprises data collected from multiple similarly configured industrial assets/devices that perform a specific industrial application within a specified industry or vertical. Each group can comprise data from multiple industrial enterprises and customers, so that analysis component 314 can identify configuration-specific performance trends, propensity for device failures, downtime patterns, energy consumption, operating costs, or other such performance metrics as a function of the configuration aspect selected as the grouping criterion.

Filtering and grouping the selected subset of indexed data in this manner allows particular asset configurations to be isolated and analyzed individually (e.g., using machine learning, data mining, or other analysis technique) so that asset performance trends can be identified for various asset configurations. These results can then be compared across the sets of configuration-specific data in order to characterize these learned performance metrics as a function of the variable asset configurations corresponding to the configuration-specific groups. This analysis allows the diagnosis and maintenance system 302 to generate asset configuration recommendations to specific customers.

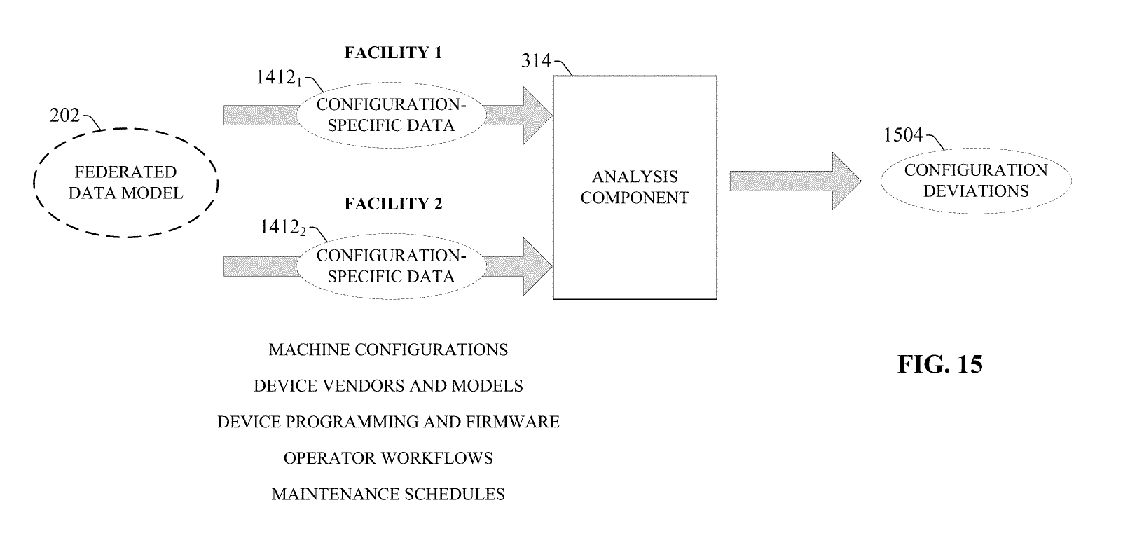

With the configuration-specific data 1412 identified and grouped according to the process described in connection with FIG. 14, the analysis component 314 can perform a comparative analysis across the data groups relative to a selected performance metric. FIG. 15 is a diagram illustrating an analysis performed by the analysis component 314 to identify system configuration deviations based on analysis of the groups of configuration-specific data 1412. As described above, the sets of configuration-specific data 1412 include information identifying the industrial devices that make up the respective automation systems (e.g., vendor and model number), device configurations for the respective devices (e.g., program code, configuration settings, firmware versions, etc.), operator workflows and/or standards that are followed when operating the automation systems, maintenance schedules for the respective automation systems, etc. The analysis component 314 can perform comparative analysis across these sets of configuration-specific data 1412 and generate, based on the analysis, configuration deviation data 1504 identifying configuration or operational differences between the respective automation systems. The differences identified by the analysis component 314 can include, for example, differences in configuration parameter settings between industrial devices that perform comparable roles within the respective automation systems (e.g., variable frequency drive settings, control loop tuning parameters, temperature settings, pressure settings, motor speed settings, etc.), differences in the vendor and/or model of the industrial devices that perform similar roles across the automation systems, differences in industrial controller programming, differences in operator workflows carried out to achieve similar goals across the different automation systems (based on the operator monitoring functions described above), differences in machine maintenance schedules, or other relevant deviations between system configurations.

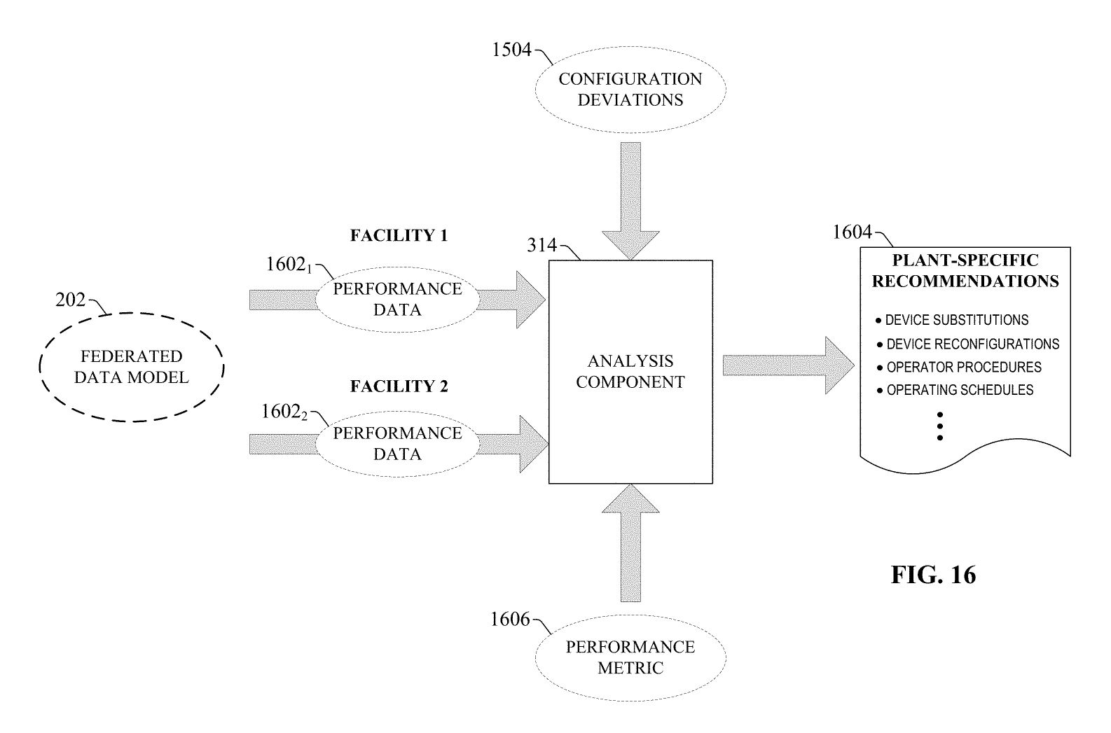

With these system configuration and operational deviations identified, the analysis component 314 can then generate one or more plant-specific recommendations based on a correlation between performance metrics of the respective automation systems and the identified system configuration deviations. FIG. 16 is a diagram illustrating an analysis performed by the analysis component 314 to generate plant-specific recommendations based on such analysis. In this example, the analysis is performed with respect to a particular performance metric 1606 specified by the user (e.g., entered by the user via the device interface component 318), or inferred by the system 302 as being a relevant performance metric. The performance metric of interest may be, for example, product output or production rate, total or average machine runtime, product quality, energy or material consumption, operating costs, average number of system abnormal conditions, or other such performance indicators.

Based on the selected performance metric 1606, the analysis component extracts sets of relevant performance data 1602 indicative of the selected performance metric from the federated data model 202, where each set of performance data 1602 corresponds to a particular automation system (e.g., the automation systems corresponding to the configuration-specific data 1412). For example, the user is interested in maximizing product throughput across all facilities, the user may select “product throughput” as the performance metric 1606, and the analysis component 314 will retrieves the product throughput data for the respective automation systems for comparative analysis. Similarly, if the user is interested in minimizing machine downtime, the analysis component 314 will extract machine runtime and/or downtime statistics for the respective automation systems from the federated data model 202.

The analysis component 314 can then perform correlation analysis that correlates the performance data 1602 for the respective automation systems with the configuration deviation data 1504 previously generated by the system. To this end, the analysis component may identify the set of performance data 1602 corresponding to a best result for the specified performance metric 1606 (e.g., the set of performance data 1602 having the highest product throughput, the least amount of system downtime, etc.), identify the automation system corresponding to the this set of performance data 1602, and identify any configuration or operational deviations for this automation system relative to other automation systems based on the configuration deviation data 1504. The analysis component 314 may also determine a subset of these identified configuration deviations that are particularly relevant to the superior performance of the corresponding automation system.

Based on results of these analyses, the analysis component 314 can generate recommendation data 1604 identifying one or more plant-specific or machine-specific recommendations for improving the specified performance metric at other facilities. These recommendations may include, for example, replacing a particular industrial device (e.g., a motor drive, an industrial controller, a sensor, etc.) on one or more of the non-optimal automation systems to match the device used in the best performing automation system. Such device replacement recommendations can include an identity of the vendor and model to be used at the other automation systems. Another example recommendation may propose changing the configuration settings on one or more industrial devices to match the settings of the corresponding device used on the optimal automation system. This type of recommendation may include the identity and location of the device to be reconfigured, the particular configuration settings to be modified, and the parameter values to be used for each setting.

In addition to device-level recommendations, the analysis component 314 may also identify operator workflows or maintenance activities that are determined to play a role in achieving the superior performance metric. For example, if the performance metric being examined is machine downtime, the analysis component 314 may determine that operators associated with the automation system having the least amount of system downtime repeatedly carry out a particular sequence of control operations in response to a particular downtime alarm or condition (e.g., a part misalignment, a quality check failure, a motor overvoltage alarm, etc.), suggesting that the sequence of operations performed by these operators—defined in terms of which control panel or HMI controls are selected and in what order the controls are actuated—represents a preferred manner of recovering from that downtime condition. Accordingly, the analysis component 314 may generate the recommendation to implement this operating sequence as the standard operating procedure for recovering from this type of downtime event.

Although the previous examples have described this analysis and generation of recommendations as being performed by the system 302 in response to a request from a user (e.g., via client device 522 in FIG. 5), in some embodiments the analysis component 314 may perform such analyses on the federated data model 202 automatically on a periodic or continuous basis, and deliver automated recommendation notifications in response to detecting that a performance metric at one or more of the facilities or automation systems can be improved by implementing the configurations or practices of a best performing facility or automation system. In such embodiments, notification component 316 can deliver such notifications to one or more client devices 522 associated with employees at the facility for which the recommendation is directed (e.g., by referencing contact information for the relevant plant personnel may be stored in association with the data model 202 on the cloud-based system). The notification component 316 can initiate delivery of such automated notification in response to one or more defined criteria relative to results generated by the analysis component 314. For example, in order to prevent excessive notifications from being delivered to the users, the notification component 316 may be configured to initiate delivery of a recommendation only in response to a determination that implementing the recommendation on the target automation system will improve performance of a particular performance metric in excess of a threshold measure (e.g., if a machine downtime will be reduced in excess of two hours per week, if energy consumption by the automation system will be reduced in excess of 5%, if product output by the automation system will increase in excess of 7%, etc.). The notification may also be generated in response to determining that the performance metric for one of the automation systems has fallen relative to that of the other similar automation systems in excess of a defined deviation threshold. These criteria can be customized by the user in order to control a rate of notification delivery relative to the user's priorities or goals.

Using these cross-facility indexing and analysis techniques, the diagnosis and maintenance system 302 can offer a high level view of a given industrial enterprise, and facilitate communication of best practices across multiple geographically distributed facilities. The system 302 can also provide a platform by which overall performance of the enterprise as a whole is improved by discovering optimal configurations and practices in place at the respective facilities and assisting plant personnel in propagating these optimal configurations and practices across the enterprise.

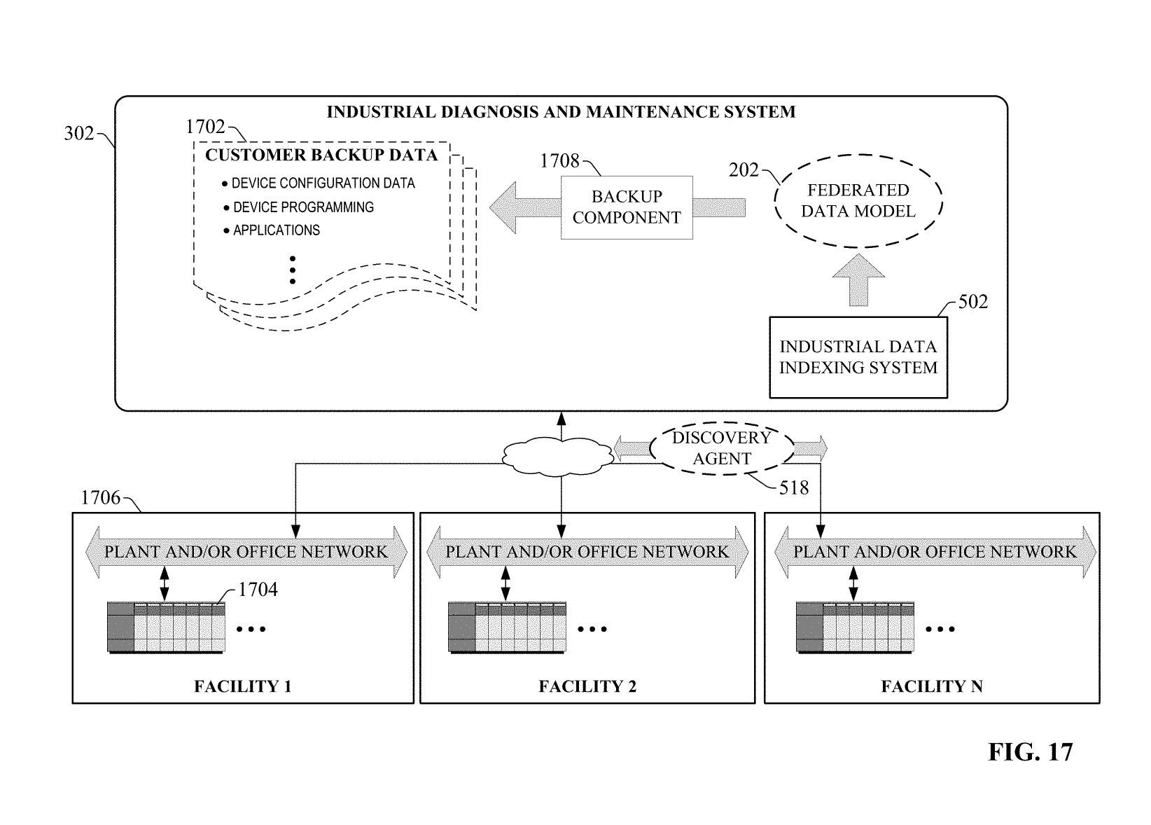

In addition to the diagnosis and maintenance features described above, one or more embodiments of the cloud-based system 302 can include tools that leverage the data indexed in the federated data model 202 to implement backup and disaster recovery features. FIG. 17 is a diagram illustrating creation of backup data for a set of industrial facilities according to one or more embodiments. Similar to previous examples, the diagnosis and maintenance system 302 includes an indexing system 502 that indexes industrial data discovered on multiple industrial facilities 1706 by one or more discovery agents 518. Since the federated data model 202 can include information regarding industrial device configurations and programming, applications in use at the respective facilities, and other such information, a backup component 1708 of the diagnosis and maintenance system 302 can create customer-specific backup data 1702 based on the relevant subsets of indexed data, and store this backup data 1702 on cloud-based storage for access and retrieval. Information contained in the backup data 1702 can include, but is not limited to, program code and configuration information for industrial controllers deployed at the facilities 1706 (e.g., ladder logic, I/O module configuration settings, network settings, etc.), configuration settings for other types of industrial devices (e.g., motor drives, smart meters, vision systems or other quality check systems, etc.), backup instances of software applications in use at the facilities 1706 (e.g., reporting applications, ERP applications, etc.), and other such information.

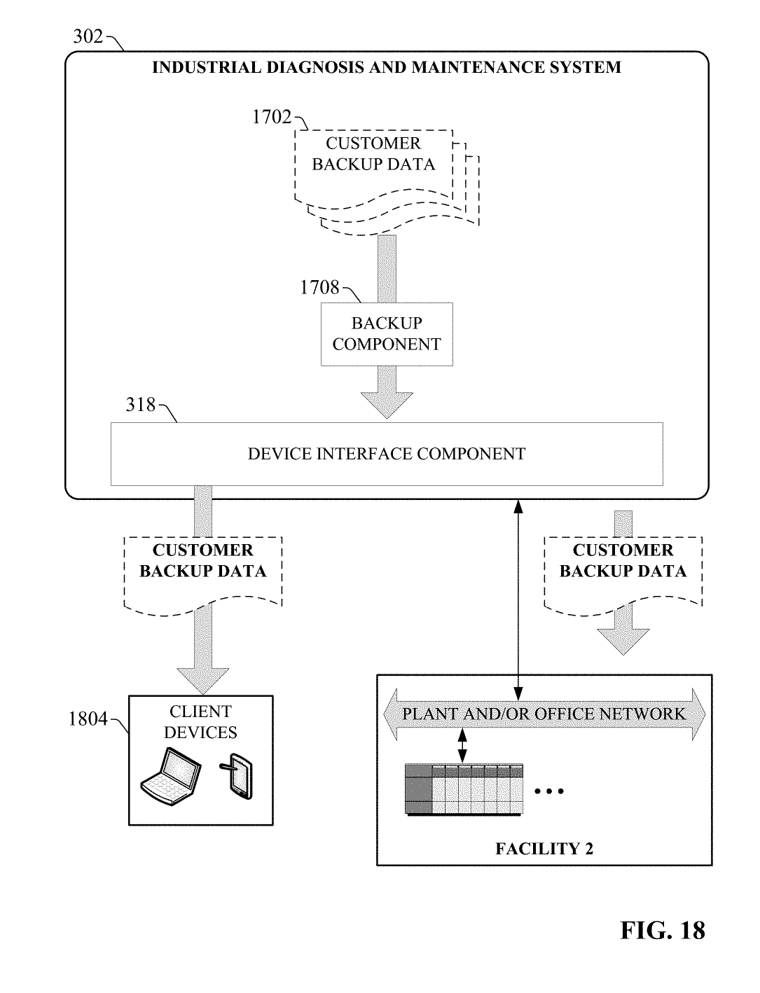

By maintaining an up-to-date set of customer backup data 1702 on the cloud platform, these embodiments of system 302 provide an automated disaster recovery system for the distributed facilities. FIG. 18 is a diagram illustrating retrieval of backup data from the system 302. In the event that an industrial device loses its configuration settings, or an application is lost or cleared of its configuration data, a user can access and retrieve the relevant subset of customer backup data 1702 via interaction with the diagnosis and maintenance system 302. To this end, the user may remotely interface with the system 302 using an authorized client device 1804 (e.g., over an internet connection or other external wireless network connection). Device interface component 318 can serve a disaster recovery interface screen to the client device 1804 that allows the user to browse and identify the sets of customer backup data 1702 according to the corresponding industrial devices or applications to which the backup data pertains. Using the graphical interface screen, the user can select the industrial device or application for which the backup data is desired and initiate a download of the selected backup data to client device 1804. Once downloaded, the backup data can be applied to the relevant device or application (e.g., by downloading the recovered configuration or program from the client device 1804 to the industrial device, or by manually configuring the industrial device based on the configuration parameters or programming displayed on the client device 1804).

In some embodiments, rather than downloading the backup data 1702 to the user's client device, the system 302 may be configured to download the backup data directly to the relevant industrial device in response to initiation of the disaster recovery sequence by the user. For example, in response to selecting and initiating a recovery operation for a selected device using client device 1804, the device interface component 318 may retrieve the selected backup data 1702, locate the corresponding device on the plant network, and download the recovered configuration or program to the target industrial device.

Since the backup component 1708 provides backup and recovery services for multiple facilities, the backup data may include backup data for similar devices and applications used at different industrial facilities. This affords an opportunity for users at a first facility to easily acquire and implement the backup device configurations or programming being used at other facilities within the enterprise. Accordingly, the device interface component 318 can allow a user at a first facility to retrieve, not only the backup data that was generated from the devices at that facility, but also to select backup data retrieved from another facility for use at the first facility. For example, the user at the first facility may decide to implement another facility's device configuration settings or programming based on a recommendation generated by analysis component 314 indicating that the settings or programming used at the other facility may improve a performance metric at the first facility. To allow the user to select this backup data, the graphical interface generated by the device interface component 318 may allow the user to view and browse backup configurations for all facilities within the enterprise, and to select backup configurations from other facilities for download to the local facility.

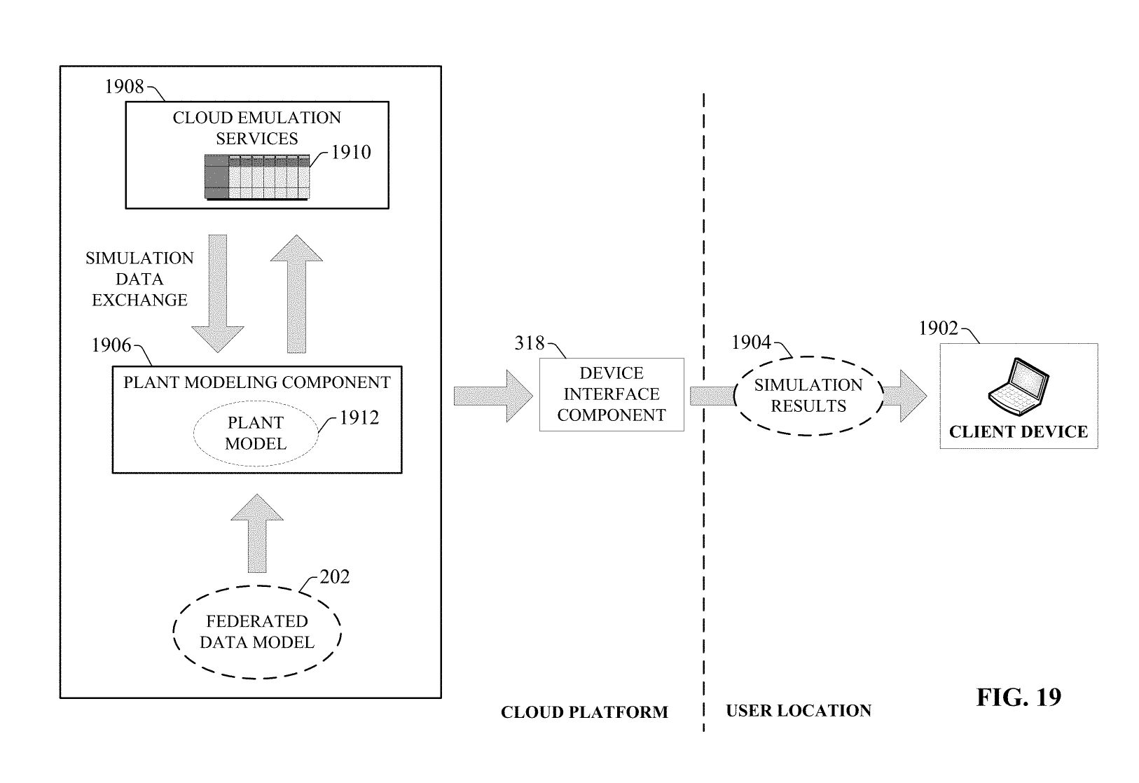

Indexing the performance, configuration, and programming data in the cloud platform at a high degree of granularity also makes cloud-based design and emulation functions possible. Accordingly, one or more embodiments of the diagnosis and maintenance system 302 can include cloud-based plant modeling and emulation services that leverage the data indexed in the federated data model 202. FIG. 19 is a diagram illustrating cloud-based modeling and emulation according to one or more embodiments. In this example embodiment, diagnosis and maintenance system 302 includes a plant modeling component 1906 as well as cloud emulation services 1908. Plant modeling component 1906 can be configured to generate an interactive plant model 1912 of a given plant facility based on relevant subsets of indexed data in the data model 202. Specifically, plant modeling component 1906 can identify the subsets of indexed data that were obtained from a given plant facility, and generate a plant model 1912 of that facility based on the indexed data. This plant model 1912 is designed to exchange simulation data with a cloud-based emulator 1910 controlled by the cloud emulation services 1908.

This architecture allows a user to safely test new control programs or machine configurations on the cloud platform without placing physical equipment at risk. To this end, the cloud-based emulator 1910 is configured to execute industrial control program against the plant model and to generate simulation results 1904 for delivery to a client device 1902. In this regard, the emulator 1910 acts as a virtualized controller that interacts with a cloud-based simulation of the plant represented by the plant model 1912. The plant model 1912 models at least a portion of an automation system within a facility from which the data was indexed, or may model multiple distributed systems.

Device interface component 318 can generate a graphical interface that allows client device 1902 to upload an industrial control program to be executed on emulator 1910 for testing. During a simulation session, the plant model 1912 exchanges information with emulator 1910 to simulate operation of the modeled industrial system. Based on the data in the plant model 1912, the plant modeling component 1906 can simulate responses of the automation system in response to inputs and outputs exchanged with the control program executed by emulator 1910 (e.g., via simulated analog and digital inputs and outputs that interface the control program with modeled representations of inputs and outputs defined by the plant model 1912. The user can observe the simulation results via the graphical interface served to client device 1902 by device interface component 318. In this way, the system 302 provides a safe platform for testing and debugging control programs, or to predict the effect of a new machine configuration on plant operation.

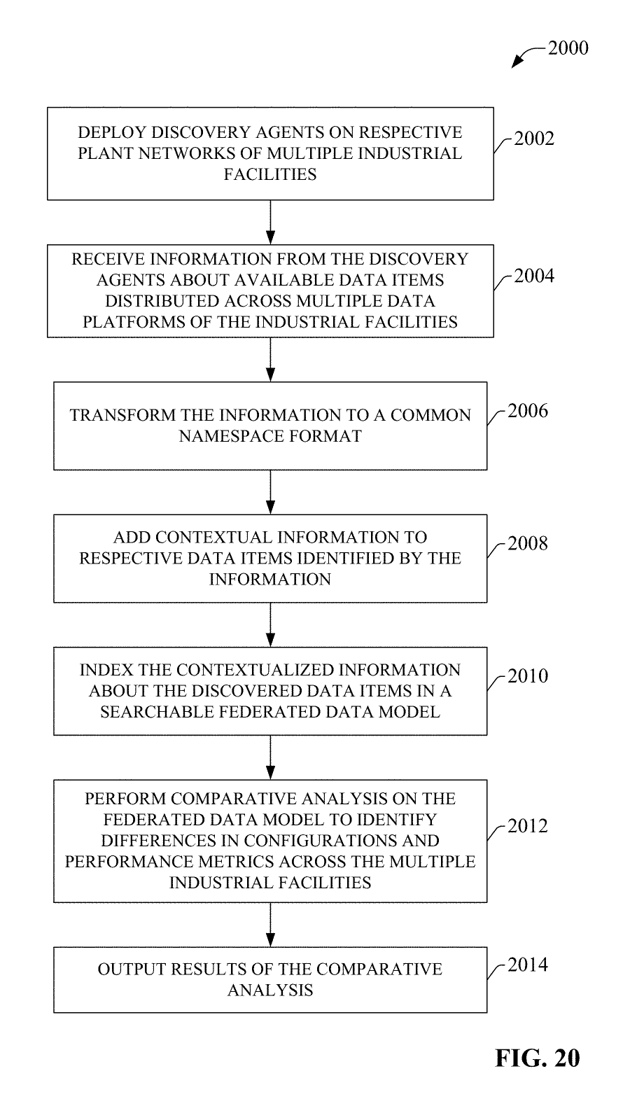

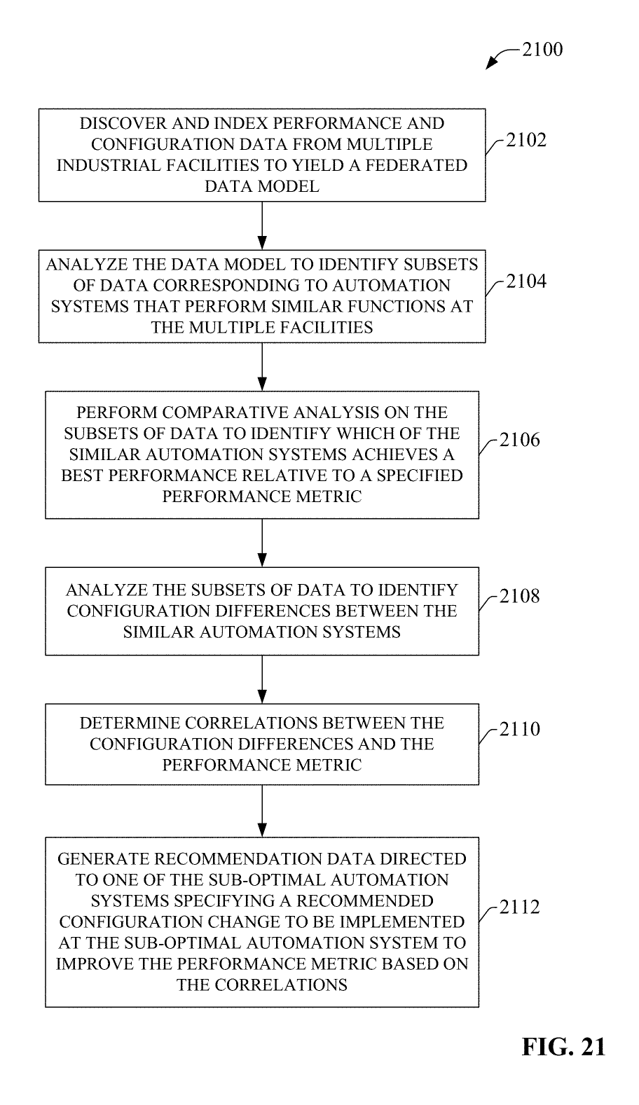

FIGS. 20-21 illustrate various methodologies in accordance with one or more embodiments of the subject application. While, for purposes of simplicity of explanation, the one or more methodologies shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 20 illustrates an example methodology 2000 for performing comparative analysis on industrial automation systems located at multiple geographically diverse facilities. Initially, at 2002, discovery agents are deployed on respective plant networks of multiple industrial facilities. The discovery agents may comprise software scripts or other data elements configured to crawl or scan their respective assigned networks and identify industrial devices and other data sources containing data items to be collected and indexed. Data sources identified by the discovery agents can include, for example, industrial devices, knowledge bases, device documentation (e.g., manuals) located on storage devices, work schedule databases, maintenance record databases, electronic communication records, etc. In some embodiments, the discovery agents can navigate the plant networks and collect information regarding devices and systems in use (e.g., industrial controllers, HMIs, motor drives, documentation repositories, inventory tracking systems, etc.), and the available data associated with each device or system. The discovery agent can also identify correlations between data items across the various devices and data platforms (e.g., identifying that a data tag referenced on a particular rung of a control logic program is also referenced on a display screen of an HMI).

At 2004, information regarding available data items distributed across multiple data platforms of the industrial facilities is received from the discovery agents. In some embodiments, the discovery agents can navigate the plant networks and collect information regarding devices and systems in use (e.g., industrial controllers, HMIs, motor drives, documentation repositories, inventory tracking systems, etc.), and the available data associated with each device or system. The discovery agent can also identify correlations between data items across the various devices and data platforms (e.g., identifying that a data tag referenced on a particular rung of a control logic program is also referenced on a display screen of an HMI).

At 2006, the information received at step 2004 is transformed to a common namespace format if the data was not already provided in this format. At 2008, contextual information is added to respective data items identified by the information. This contextual information may include, for example, a plant facility, production area, machine, or device on which the data was discovered; a relationship or interdependency between a given data item and another data item; a data platform corresponding to the data item (e.g., industrial control program, HMI application, knowledgebase article, device documentation, etc.), one or more employees having an association with the data items, or other such information. At 2010, the contextualized information about the discovered data items is indexed in a searchable federated data model.

At 2012, comparative analysis is performed on the federated data model to identify differences in configurations and performance metrics across the multiple industrial facilities. In an example of such analysis, the data model can be analyzed to identify subsets of data that are associated with respective automation systems that carry out a similar function, where the automation systems may be located in different plant facilities. For example, the analysis may identify automation systems located at different facilities that each carry out a similar batch process, die casting process, part stamping process, machining process, or other types of processes. Comparative analysis can then be performed on the subsets of data to identify differences in system configurations and/or operator procedures between the systems. These differences may include, for example, differences in device programming or configuration, differences in firmware revisions installed on equivalent devices across the different automation systems, differences in maintenance schedules applied to the automation systems, differences in operator procedures used to recover from specific downtime events, etc. The comparative analysis can also identify differences in performance metrics between the different automation systems. These performance metrics may include, for example, product throughput, average or total system downtimes, product quality, energy efficiency, operating costs, etc.

At 2014, results of the comparative analysis performed at step 2012 are output. In an example embodiment, the results may be output in the form of a report conveying the relative performance metrics between the automation systems, recommendations for standardizing the confirmations of all the automation systems to conform to the configuration of the system having a best performance metric, or other such outputs.

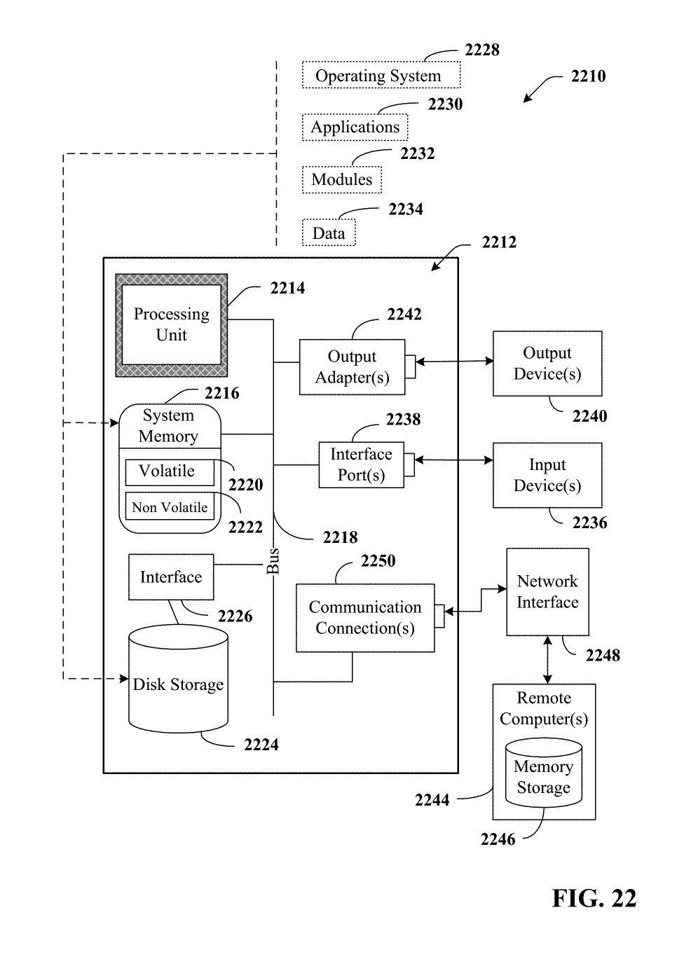

FIG. 21 illustrates an example methodology 2100 for generating automated recommendations for optimizing performance of one or more industrial automation systems. Initially, at step 2102, performance and configuration data from multiple industrial facilities is discovered and indexed to yield a federated data model (e.g., using techniques similar to those described above in connection with steps 2002-2010 of FIG. 22). At 2104, the data model is analyzed to identify subsets of data corresponding to automation systems that perform a similar function (e.g., a similar batch process, a similar machining process, etc.) at the multiple facilities.

At 2106, comparative analysis is performed on the subsets of data to identify which of the systems achieves a best performance relative to a specified performance metric. For example, a user may select a performance metric of interest—e.g., energy efficiency, product throughput, product quality, operating cost, etc.—and the comparative analysis will be performed to identify, based on the indexed data, which of the automation systems performs best in terms of the selected performance metric.

At 2108, the subsets of data are further analyzed to identify configuration differences between the similar automation systems. Such analysis may identify, for example, differences in the vendor and model of certain industrial devices that carry out similar functions within the automation systems, differences in configuration parameter settings for the industrial devices, differences in programming code (e.g., industrial controller code), or other such differences. The analysis may also identify differentiating factors that are external to the systems themselves. Such extrinsic factors may include, for example, differences in operator workflows (e.g., the sequences of operations performed by the system operators in response to certain machine downtime events, maintenance schedules for the respective automation systems, etc.).

At 2110, correlations between the configuration differences identified at 2108 and the performance metric are determined. For example, machine learning or other analysis techniques can be applied to the analysis results obtained at steps 2106 and 2108 to determine which of the configuration differences obtained at step 2108 are likely to play a role in achieving the superior performance metric of the best performing automation system.

AT 2112, recommendation data is generated based on the correlations identified at step 2110, where the generation data is directed to one of the sub-optimal automation systems and specifies a recommended configuration change to be implemented at the sub-optimal automation system to improve the performance metric for that system. This recommendation data may identify, for example, a recommendation to replace an industrial device within the automation system with a different device model, a recommendation to modify one or more device configuration parameters, a recommendation to update the firmware on an industrial device, a recommendation to change an operator sequence for recovering from a particular machine downtime event, a recommended setpoint modification (e.g., a temperature, pressure, or flow setpoint), or other such recommendations.

Embodiments, systems, and components described herein, as well as industrial control systems and industrial automation environments in which various aspects set forth in the subject specification can be carried out, can include computer or network components such as servers, clients, programmable logic controllers (PLCs), automation controllers, communications modules, mobile computers, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, instrumentation, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, and Ethernet/IP. Other networks include Ethernet, DH/DH+, Remote I/O, Fieldbus, Modbus, Profibus, CAN, wireless networks, serial protocols, near field communication (NFC), Bluetooth, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

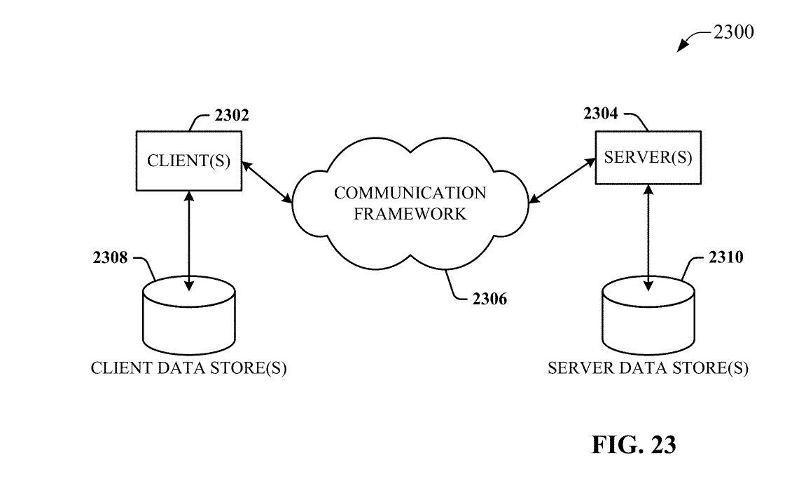

In order to provide a context for the various aspects of the disclosed subject matter, FIGS. 22 and 23 as well as the following discussion are intended to provide a brief, general description of a suitable environment in which the various aspects of the disclosed subject matter may be implemented.

With reference to FIG. 22, an example environment 2210 for implementing various aspects of the aforementioned subject matter includes a computer 2212. The computer 2212 includes a processing unit 2214, a system memory 2216, and a system bus 2218. The system bus 2218 couples system components including, but not limited to, the system memory 2216 to the processing unit 2214. The processing unit 2214 can be any of various available processors. Multi-core microprocessors and other multiprocessor architectures also can be employed as the processing unit 2214.

The system bus 2218 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 2216 includes volatile memory 2220 and nonvolatile memory 2222. The basic input/output system (BIOS), containing the basic routines to transfer information between elements within the computer 2212, such as during start-up, is stored in nonvolatile memory 2222. By way of illustration, and not limitation, nonvolatile memory 2222 can include read only memory (ROM), programmable ROM (PROM), electrically programmable ROM (EPROM), electrically erasable PROM (EEPROM), or flash memory. Volatile memory 2220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 2212 also includes removable/non-removable, volatile/nonvolatile computer storage media. FIG. 22 illustrates, for example a disk storage 2224. Disk storage 2224 includes, but is not limited to, devices like a magnetic disk drive, floppy disk drive, tape drive, Jaz drive, Zip drive, LS-100 drive, flash memory card, or memory stick. In addition, disk storage 2224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 2224 to the system bus 2218, a removable or non-removable interface is typically used such as interface 2226.

It is to be appreciated that FIG. 22 describes software that acts as an intermediary between users and the basic computer resources described in suitable operating environment 2210. Such software includes an operating system 2228. Operating system 2228, which can be stored on disk storage 2224, acts to control and allocate resources of the computer 2212. System applications 2230 take advantage of the management of resources by operating system 2228 through program modules 2232 and program data 2334 stored either in system memory 2216 or on disk storage 2224. It is to be appreciated that one or more embodiments of the subject disclosure can be implemented with various operating systems or combinations of operating systems.

A user enters commands or information into the computer 2212 through input device(s) 2236. Input devices 2236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2214 through the system bus 2218 via interface port(s) 2238. Interface port(s) 2238 include, for example, a serial port, a parallel port, a game port, and a universal serial bus (USB). Output device(s) 2240 use some of the same type of ports as input device(s) 2236. Thus, for example, a USB port may be used to provide input to computer 2212, and to output information from computer 2212 to an output device 2240. Output adapters 2242 are provided to illustrate that there are some output devices 2240 like monitors, speakers, and printers, among other output devices 2240, which require special adapters. The output adapters 2242 include, by way of illustration and not limitation, video and sound cards that provide a means of connection between the output device 2240 and the system bus 2218. It should be noted that other devices and/or systems of devices provide both input and output capabilities such as remote computer(s) 2244.

Computer 2212 can operate in a networked environment using logical connections to one or more remote computers, such as remote computer(s) 2244. The remote computer(s) 2244 can be a personal computer, a server, a router, a network PC, a workstation, a microprocessor based appliance, a peer device or other common network node and the like, and typically includes many or all of the elements described relative to computer 2212. For purposes of brevity, only a memory storage device 2246 is illustrated with remote computer(s) 2244. Remote computer(s) 2244 is logically connected to computer 2212 through a network interface 2248 and then physically connected via communication connection 2250. Network interface 2248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL). Network interface 2248 can also encompass near field communication (NFC) or Bluetooth communication.

Communication connection(s) 2250 refers to the hardware/software employed to connect the network interface 2248 to the system bus 2218. While communication connection 2250 is shown for illustrative clarity inside computer 2212, it can also be external to computer 2212. The hardware/software necessary for connection to the network interface 2248 includes, for exemplary purposes only, internal and external technologies such as, modems including regular telephone grade modems, cable modems and DSL modems, ISDN adapters, and Ethernet cards.

FIG. 23 is a schematic block diagram of a sample computing environment 2300 with which the disclosed subject matter can interact. The sample computing environment 2300 includes one or more client(s) 2302. The client(s) 2302 can be hardware and/or software (e.g., threads, processes, computing devices). The sample computing environment 2300 also includes one or more server(s) 2304. The server(s) 2304 can also be hardware and/or software (e.g., threads, processes, computing devices). The servers 2304 can house threads to perform transformations by employing one or more embodiments as described herein, for example. One possible communication between a client 2302 and servers 2304 can be in the form of a data packet adapted to be transmitted between two or more computer processes. The sample computing environment 2300 includes a communication framework 2306 that can be employed to facilitate communications between the client(s) 2302 and the server(s) 2304. The client(s) 2302 are operably connected to one or more client data store(s) 2308 that can be employed to store information local to the client(s) 2302. Similarly, the server(s) 2304 are operably connected to one or more server data store(s) 2310 that can be employed to store information local to the servers 2304.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. A system for analyzing performance of industrial automation systems across multiple facilities, comprising:
a memory that stores computer-executable components;
a processor, operatively coupled to the memory, that executes the computer-executable components, the computer-executable components comprising:
a discovery component configured to discover available data items distributed across multiple data sources of multiple industrial facilities;
an indexing component configured to record the data items in a searchable federated data model;
an analysis component configured to identify sets of data items recorded in the federated data model that correspond to respective automation systems in operation at the multiple industrial facility, and to perform comparative analysis across the sets of data items; and
a device interface component configured to output recommendation data based on a result of the comparative analysis, wherein the recommendation data identifies a recommended modification to one or more of the automation systems determined to improve a performance metric.

2. The system of claim 1, wherein the discovery component is configured to deploy discovery agents on respective plant networks of the industrial facilities and to receive information regarding the available data items from the discovery agents.

3. The system of claim 1, wherein the device interface component is configured to receive, via interaction with a graphical interface display, performance metric selection data identifying the performance metric, and wherein the analysis component is configured to determine, based on the comparative analysis, which of the automation systems achieves a highest value for the performance metric.

4. The system of claim 3, wherein the performance metric comprises at least one of a throughput of a product manufactured by the automation systems, a quality of the product, an average downtime duration of the automation systems, a total downtime duration of the automation systems, an energy efficiency of the automation systems, or an operating cost of the automation systems.

5. The system of claim 3, wherein the analysis component is further configured to identify configuration differences between the automation systems based on the comparative analysis, and to correlate the configuration differences with the performance metric.

6. The system of claim 5, wherein the analysis component is configured to determine the recommended modification based on identified correlations between the configuration differences and the performance metric.

7. The system of claim 5, wherein the recommended modification comprises at least one of a recommended modification to a device configuration, a recommended device replacement, a recommended modification to a maintenance schedule, a recommended change in operator actions in response to a downtime event, a recommended setpoint modification, a recommended firmware upgrade, or a recommended modification to an industrial control program.

8. The system of claim 3, wherein at least one of the one or more data sources comprises an industrial device, and the discovery agents are configured to identify at least one of the available data items based on an analysis of at least one of a control program executing on the industrial device, a configuration file on the industrial device, or a tag list defined on the industrial device.

9. The system of claim 1, wherein the multiple data sources comprise at least one of an industrial device, a knowledgebase storage device, a device documentation storage device, a work schedule storage device, a maintenance record data storage device, or an electronic communication log storage device.

10. The system of claim 1, wherein the discovery component is further configured to identify at least one interdependency between two or more of the available data items.

11. A method for improving performance of industrial automation systems, comprising:
discovering, by a system comprising a processor, available data items located on data sources located at multiple industrial plants;
indexing, by the system, the available data items in a searchable federated data model;
identifying, by the system, sets of data items indexed in the federated data model that correspond to respective automation systems operating in the multiple industrial plants;
performing, by the system, comparative analysis on the sets of data items; and
generating, by the system, recommendation data based on a result of the comparative analysis, wherein the recommendation data identifies a recommended modification to one or more of the automation systems determined to improve a performance metric.

12. The method of claim 11, wherein the discovering comprises:
deploying discovery agents on respective plant networks of the industrial plants; and
receiving information regarding the available data items from the discovery agents.

13. The method of claim 11, wherein the performing the comparative analysis comprises:
receiving, via interaction with a graphical interface display, performance metric selection data that selects the performance metric; and
determining which of the automation systems yields a highest value for the performance metric based on analysis of the federated data model.

14. The method of claim 13, wherein the receiving comprises selecting, as the performance metric, at least one of a throughput of a product manufactured by the automation systems, a quality of the product, an average downtime duration of the automation systems, a total downtime duration of the automation systems, an energy efficiency of the automation systems, or an operating cost of the automation systems.

15. The method of claim 13, wherein the performing the comparative analysis further comprises:
identifying configuration differences between the automation systems; and
correlating the configuration differences with the performance metric.

16. The method of claim 15, wherein the generating the recommendation data comprises determining the recommended modification based on results of the correlating.

17. The method of claim 15, wherein the generating the recommendation data comprises identifying as the recommended modification, at least one of a recommended modification to a device configuration, a recommended device replacement, a recommended modification to a maintenance schedule, a recommended change in operator actions in response to a downtime event, a recommended setpoint modification, a recommended firmware upgrade, or a recommended modification to an industrial control program.

18. A non-transitory computer-readable medium having stored thereon instructions that, in response to execution, cause a system comprising a processor to perform operations, the operations comprising:
discovering available data items located on data sources located at multiple industrial plants;
indexing the available data items in a searchable federated data model;
identifying sets of data items indexed in the federated data model that correspond to respective automation systems operating in the multiple industrial plants;
performing comparative analysis on the sets of data items; and
generating recommendation data based on a result of the comparative analysis, wherein the recommendation data identifies a recommended modification to one or more of the automation systems determined to improve a performance metric.

19. The non-transitory computer-readable medium of claim 18, wherein the performing the comparative analysis comprises:
receiving, via interaction with a graphical interface display, performance metric selection data that selects the performance metric; and
determining which of the automation systems yields a highest value for the performance metric.

20. The non-transitory computer-readable medium of claim 19, wherein the performing the comparative analysis further comprises:
identifying configuration differences between the automation systems; and
correlating the configuration differences with the performance metric.
